(19) United States
(12) Patent Application Publication
(10) Pub. No.: US 2026/0095652 A1
(43) Pub. Date: Apr. 2, 2026

(54) CAPTURE CONTROL APPARATUS AND CAPTURE CONTROL METHOD

(71) Applicant: CANON KABUSHIKI KAISHA, Tokyo (JP)

(72) Inventor: MASAHARU YAMAGISHI, Kanagawa (JP)

(21) Appl. No.: 19/335,565

(22) Filed: Sep. 22, 2025

(30) Foreign Application Priority Data
Sep. 30, 2024 (JP) 2024-171512

(51) Int. Cl. H04N 23/66; H04N 23/62; H04N 23/63; H04N 23/695

(52) U.S. Cl. CPC H04N 23/66; H04N 23/62; H04N 23/63; H04N 23/695

(57) ABSTRACT

Disclosed is a capture control apparatus that controls a performance of a second image capture apparatus among a plurality of image capture apparatuses including a first image capture apparatus and the second image capture apparatus, based on information related to the first image capture apparatus and control descriptions that have been set. In a case where the first image capture apparatus has been changed within the plurality of image capture apparatuses, the capture control apparatus determines whether a difference between an orientation of an operation member for remotely controlling a capture direction of the first image capture apparatus and an orientation of the current first image capture apparatus is equal to or smaller than a threshold. If the difference is not equal to or smaller than the threshold, the capture control apparatus disables the remote control by the operation member until the difference is equal to or smaller than the threshold.

### BACKGROUND

### Field of the Technology

The present disclosure relates to a capture control apparatus and a capture control method, and especially relates to a technique to control a plurality of image capture apparatuses.

### Description of the Related Art

Japanese Patent Laid-Open No. 2020-25248 describes an image capture system in which a plurality of cameras are classified as a main camera and a sub camera, and the sub camera is controlled so as to capture the same subject as the main camera.

In the image capture system described in Japanese Patent Laid-Open No. 2020-25248, pan and tilt performances of the main camera are remotely controlled via an operation on a joystick or a GUI displayed on a screen. However, such a remote operation is different in feeling from a case where a camera platform on which the main camera is mounted is operated directly. Therefore, it takes practice to be able to control a capture direction as intended. Such a difference in the feeling of operation can be a problem especially in a case where image capture in an environment where a camera is supposed to be operated on site, such as image capture in a studio, is attempted to be realized by a remote operation.

### SUMMARY

A part of embodiments according to the present disclosure provides a capture control apparatus and a capture control method capable of performing a remote operation on a capture direction of an image capture apparatus more intuitively.

According to an aspect of the present disclosure, there is provided a capture control apparatus, comprising: one or more processors that execute a program stored in a memory, wherein the program, when executed by the one or more processors, causes the one or more processors to perform: controlling a performance of a second image capture apparatus among a plurality of image capture apparatuses including a first image capture apparatus and the second image capture apparatus, based on information related to the first image capture apparatus and control descriptions that have been set; and in a case where the first image capture apparatus has been changed within the plurality of image capture apparatuses, determining whether a difference between an orientation of an operation member for remotely controlling a capture direction of the first image capture apparatus and an orientation of the current first image capture apparatus is equal to or smaller than a threshold, wherein in a case where it has been determined that the difference is not equal to or smaller than the threshold, the controlling disables the remote control by the operation member until it is determined that the difference is equal to or smaller than the threshold.

According to another aspect of the present disclosure, there is provided a capture control method comprising: controlling a performance of a second image capture apparatus among a plurality of image capture apparatuses including a first image capture apparatus and the second image capture apparatus, based on information related to the first image capture apparatus and control descriptions that have been set; in a case where the first image capture apparatus has been changed within the plurality of image capture apparatuses, determining whether a difference between an orientation of an operation member for remotely controlling a capture direction of the first image capture apparatus and an orientation of the current first image capture apparatus is equal to or smaller than a threshold; and in a case where it has been determined that the difference is not equal to or smaller than the threshold, disabling the remote control by the operation member until it is determined that the difference is equal to or smaller than the threshold.

According to a further aspect of the present disclosure, there is provided a non-transitory computer-readable medium storing a program for causing a computer to perform a capture control method comprising: controlling a performance of a second image capture apparatus among a plurality of image capture apparatuses including a first image capture apparatus and the second image capture apparatus, based on information related to the first image capture apparatus and control descriptions that have been set; in a case where the first image capture apparatus has been changed within the plurality of image capture apparatuses, determining whether a difference between an orientation of an operation member for remotely controlling a capture direction of the first image capture apparatus and an orientation of the current first image capture apparatus is equal to or smaller than a threshold; and in a case where it has been determined that the difference is not equal to or smaller than the threshold, disabling the remote control by the operation member until it is determined that the difference is equal to or smaller than the threshold.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram of an image capture system according to a first embodiment.

FIG. 2 is a block diagram showing an exemplary functional configuration of each apparatus in the image capture system according to the first embodiment.

FIG. 3 is a diagram showing a capture control apparatus according to an embodiment, with a focus on main performances and flows of signals.

FIG. 4 is a diagram showing examples of roles and control descriptions that can be set on a sub camera according to an embodiment.

FIG. 5 is a flowchart related to role deciding processing according to the first embodiment.

FIG. 6A to FIG. 6D are flowcharts related to performances of each apparatus in the image capture system according to an embodiment.

FIG. 7A and FIG. 7B are diagrams for describing a coordinate transformation according to an embodiment.

FIG. 8A and FIG. 8B are diagrams related to subject detection and a coordinate transformation according to an embodiment.

FIG. 9A to FIG. 9C are schematic diagrams of control on performances of a sub camera according to the first embodiment.

FIG. 10A to FIG. 10C are schematic diagrams of another control on performances of a sub camera according to the first embodiment.

FIG. 11 is a diagram for describing calculation of a pan angle according to an embodiment.

FIG. 12 is a diagram for describing calculation of a tilt angle according to an embodiment.

FIG. 13 is a diagram showing an example of mapping of zoom values of a main camera and a sub camera according to the first embodiment.

FIG. 14 is a flowchart related to processing for deciding on the control descriptions corresponding to a role of a sub camera according to the first embodiment.

FIG. 15 is a schematic diagram of control corresponding to a role of a sub camera according to the first embodiment.

FIG. 16 is a schematic diagram of control corresponding to a role of a sub camera according to the first embodiment.

FIG. 17 is a schematic diagram showing an exemplary external view of a remote control apparatus according to the first embodiment.

FIG. 18A and FIG. 18B are diagrams showing examples of the directions of respective cameras before and after the roles have been changed.

FIG. 19A and FIG. 19B are diagrams for describing inconsistency between the orientations of a main camera and an operation unit.

FIG. 20 is a flowchart related to performances at the time of change of a main camera according to the first embodiment.

FIG. 21 is a timing chart related to performances at the time of change of a main camera according to the first embodiment.

FIG. 22A and FIG. 22B are flowcharts related to performances during a disabled period of a remote control apparatus according to a second embodiment.

FIG. 23A and FIG. 23B are diagrams showing display examples according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### (Overview of Multi-Camera Image Capture System)

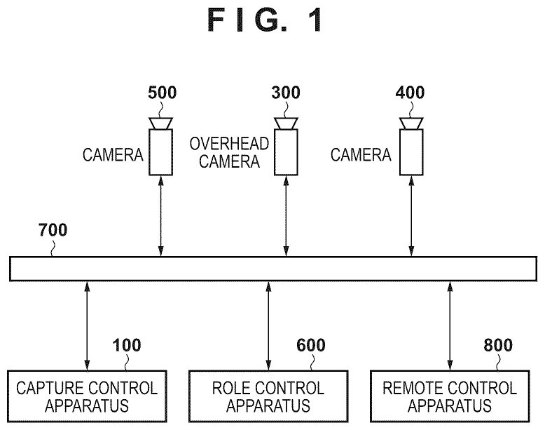

FIG. 1 is a schematic diagram showing a configuration of a multi-camera image capture system 10 (hereinafter simply referred to as an image capture system) according to the present embodiment. The image capture system 10 includes a plurality of cameras 300, 400, and 500, a capture control apparatus 100, and a role control apparatus 600. The plurality of cameras 300, 400, and 500, the capture control apparatus 100, and the role control apparatus 600 are connected in such a manner that they can perform communication via a communication network 700.

The communication network 700 conforms with a known wired or wireless communication standard, such as the IEEE 802.3 series and the IEEE 802.11 series. Furthermore, each of the plurality of cameras 300, 400, and 500, the capture control apparatus 100, and the role control apparatus 600 include a communication interface that conforms with the standard of the communication network 700.

Among the plurality of cameras 300, 400, and 500, the camera 300 captures an entirety of a predetermined captured area. The captured area is set as, for example, an area in which subjects to be captured can exist in a studio. Therefore, all of the subjects inside the captured area are captured in a video of the camera 300.

The purpose of the camera 300 is to capture images for detecting subjects to be captured that exist inside the captured area. Therefore, the capture direction and the angle of view of the camera 300 are determined in accordance with the position and the captured area of the camera 300, and are basically fixed during image capture. Furthermore, it is desirable that the camera 300 captures the entirety of the captured area without an object outside the captured area hiding the captured area. For this reason, here, the camera 300 is placed at a position where an overhead view of the entirety of the captured area is attained. Hereinafter, the camera 300 will be referred to as an overhead camera for distinction from other cameras 400 and 500 whose capture directions and angles of view are not basically fixed during image capture. However, the position of placement of the camera 300 is not limited to a position where an overhead view of the captured area is attained. The operations of the overhead camera 300 can be controlled from the capture control apparatus 100.

The cameras 400 and 500 are, for example, PTZ cameras, and the performances thereof, including the capture directions (pan and tilt angles) and angles of view (zooming), can be controlled from an external apparatus. Note that the cameras 400 and 500 may be configured by placing video cameras on which a remote operation including zooming can be performed on electric camera platforms whose pan and tilt angles can be remotely controlled, for example.

Although the preset description pertains to a case where the number of cameras other than the overhead camera 300 is two (the camera 400 and the camera 500), the number of such cameras may be three or more. Among the plurality of cameras other than the overhead camera 300, one is set as a main camera (a first image capture apparatus) that acts as a target of a remote operation by the remote control apparatus 800. Also, the remaining camera is set as a sub camera (a second image capture apparatus) whose performance is controlled by the capture control apparatus 100 based on the state of the camera that is the target of remote control. Therefore, each of the plurality of cameras other than the overhead camera 300 can be remotely controlled from either of the remote control apparatus 800 and the capture control apparatus 100.

Each of the camera 400 and the camera 500 can be set as a main camera. Also, the setting of a main camera can be dynamically changed. Therefore, hereinafter, the cameras 400 and 500 will be referred to as a main camera or a sub camera in accordance with settings at that time.

It is assumed that, regarding the plurality of cameras other than the overhead camera 300, a main camera is set by the role control apparatus 600. The setting of the main camera may be configured by an operator of the role control apparatus 600, or may be configured automatically by the role control apparatus 600 in accordance with a preset condition indicating that the main camera is switched in sequence in a constant cycle, for example. The role control apparatus 600 notifies each of the remote control apparatus 800 and the capture control apparatus 100 of the setting of the main camera (e.g., unique information, an IP address, and the like of the main camera).

In the following description, it is assumed that the camera 500 is set as a main camera, and the camera 400 is set as a sub camera, for the sake of convenience.

In the present embodiment, it is assumed that operators are present for the role control apparatus 600 and the remote control apparatus 800. An operator may be present also for the capture control apparatus 100, but this operator is not indispensable. The same operator may be in charge of operations on a plurality of apparatuses. A photographer is not necessary for the overhead camera 300 and the sub camera 400 because image capture thereof is controlled by the capture control apparatus 100. Image capture of the main camera 500 is remotely controlled by the operator of the remote control apparatus 800.

Although the illustration of FIG. 1 indicates that all signals are communicated via the communication network 700, for example, video signals and control signals may be communicated using different methods. For example, each of the plurality of cameras 300, 400, and 500 may supply video signals directly to the capture control apparatus 100 and the remote control apparatus 800 via a cable. In this case, the cameras 300, 400, and 500, the capture control apparatus 100, and the remote control apparatus 800 include communication circuits conforming to the standard of video signals. The standard of video signals is, for example, the serial digital interface (SDI) standard, the high-definition multimedia interface (HDMI) R standard, or the like, but is not limited thereto.

The remote control apparatus 800 remotely controls a capture direction (pan and tilt angles) of the main camera (here, the camera 500) set by the role control apparatus 600 via the capture control apparatus 100. The remote control apparatus 800 may perform a remote operation also with respect to a zoom performance of the main camera.

The capture control apparatus 100 detects subjects from video signals received from the overhead camera 300. The capture control apparatus 100 decides on a capture direction (pan and tilt angles) and an angle of view (zoom value) of the sub camera based on the result of detection of the subjects, the state of the main camera 500, and the role set for the sub camera. The capture control apparatus 100 transmits a control command including the decided capture direction and angle of view to the sub camera 400. Changing the role setting can change the method of deciding on the capture direction and the angle of view of the sub camera 400, thereby increasing the degree of freedom in controlling the performance of the sub camera 400.

The capture control apparatus 100 also obtains orientation information from the remote control apparatus 800, and controls a capture direction of the main camera. Zoom operation information is obtained from the remote control apparatus 800, and an angle of view of the main camera is controlled.

### (Exemplary Functional Configuration of Each Apparatus)

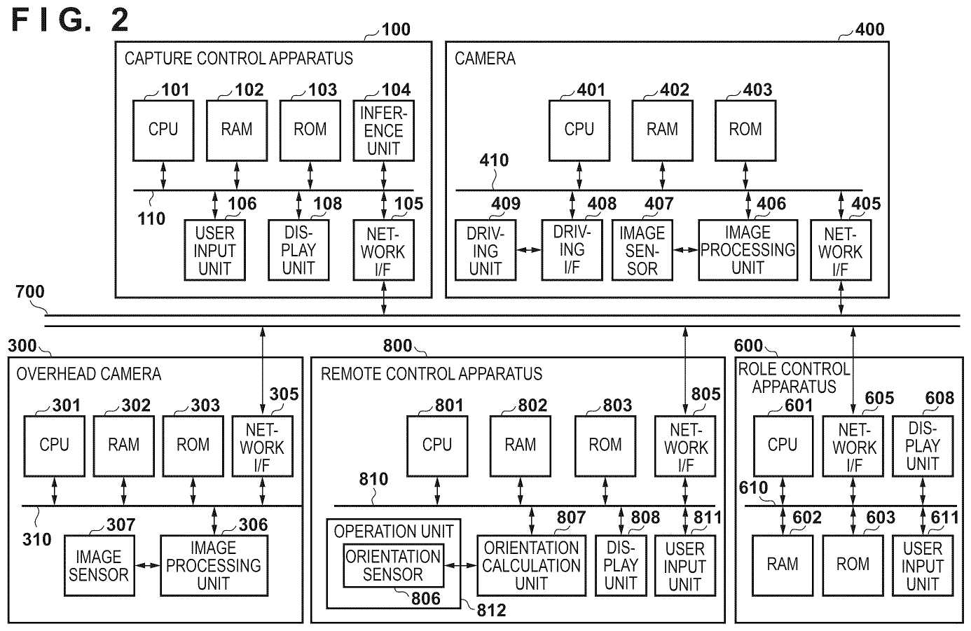

FIG. 2 is a block diagram showing a functional configuration of each device that composes a multi-camera image capture system shown in FIG. 1. Note that the constituents represented as functional blocks in the figure can be realized by an integrated circuit, such as an ASIC and an FPGA, a discrete circuit, or a combination of a memory and a processor that executes a program stored in the memory. Also, one functional block may be realized by a plurality of integrated circuit packages, or a plurality of functional blocks may be realized by one integrated circuit package. Furthermore, the same functional block may be implemented as different constituents depending on the operating environment, required capabilities, and so on.

### (Capture Control Apparatus 100)

First, a functional configuration of the capture control apparatus 100 will be described. The capture control apparatus 100 may be, for example, a general-purpose computer device, such as a personal computer and a workstation. The capture control apparatus 100 is configured in such a manner that a CPU 101, a RAM 102, a ROM 103, an inference unit 104, a network interface (I/F) 105, a user input unit 106, and a display unit 108 are connected to one another via an internal bus 110.

The CPU 101 is a microprocessor capable of executing programmed instructions. The CPU 101 realizes the functions of the capture control apparatus 100, which will be described later, by reading a program stored in the ROM 103 into the RAM 102 and executing the program, for example. The CPU 101 can realize the functions of the capture control apparatus 100 by, for example, executing a capture control application that operates on base software (OS).

The RAM 102 is used to load the program executed by the CPU 101, and to temporarily store data that is processed by the CPU 101, data that is currently processed, and so forth. Also, a part of the RAM 102 may be used as a video memory for the display unit 108.

The ROM 103 is a nonvolatile rewritable memory, and stores the program (OS and application) executed by the CPU 101, user data, and so forth.

The inference unit 104 executes processing for detecting subject regions using a machine learning model with respect to a video of the overhead camera 300. The inference unit 104 can be implemented using a hardware circuit that can execute computation of the machine learning model at high speed, such as a graphics processing unit (GPU) and a neural network processing unit (NPU), for example. Alternatively, the inference unit 104 may be implemented using a reconfigurable logic circuit, such as a field-programmable gate array (FPGA). The CPU 101 may realize the functions of the inference unit 104 by executing the program.

The machine learning model may be a convolutional neural network (CNN) that has been trained in accordance with the type of subjects to be detected. It is assumed here that the inference unit 104 detects human body regions or human face regions as subject regions from an input image. Also, it is assumed that the inference unit 104 outputs, for each detected subject region, the position and the size of a rectangular region in which the subject region is inscribed, and a detection reliability degree. Note that processing for detecting different types of subject regions may be executed with respect to the same input image using a plurality of types of machine learning models. Note that the inference unit 104 may execute processing for detecting subject regions using a known method that does not use a machine learning model. The inference unit 104 can detect subject regions using, for example, a method that uses local feature amounts, such as SIFT and SURF, a method that uses pattern matching, or the like.

The network I/F 105 is an interface for connecting the capture control apparatus 100 to the communication network 700. The capture control apparatus 100 (CPU 101) can communicate with external apparatuses in the communication network 700, such as the overhead camera 300, the sub camera 400, the main camera 500, and the role control apparatus 600, via the network I/F 105. Note that the capture control apparatus 100 may communicate with external apparatuses via another non-illustrated communication interface (a USB, Bluetooth™, or the like).

In order to communicate with each apparatus (the overhead camera 300, the sub camera 400, the main camera 500, and the role control apparatus 600) in the communication network 700, the CPU 101 obtains a network address of each apparatus at an arbitrary timing, and stores the same into the RAM 102. Furthermore, the CPU 101 also obtains information of each apparatus (the type, model name, and the like of the apparatus) at an arbitrary timing (e.g., at the time of first communication), and stores the same into the RAM 102. It is assumed that, as described above, the CPU 101 is aware of at least identification information and the types of apparatuses with respect to the overhead camera 300, the sub camera 400, the main camera 500, and the role control apparatus 600. Note that the user may be allowed to give any name to each individual apparatus.

The user input unit 106 is an input device (not shown), such as a mouse, a keyboard, and a touch panel. The capture control apparatus 100 accepts a user instruction via the user input unit 106.

The display unit 108 is a display apparatus, such as a liquid crystal display (LCD). The display unit 108 displays a GUI screen provided by the OS, the capture control application, or the like.

### (Overhead Camera 300)

Next, a functional configuration of the overhead camera 300 will be described.

A CPU 301 is a microprocessor capable of executing programmed instructions. The CPU 301 controls the operations of each functional block and realizes the functions of the overhead camera 300, which will be described later, by reading a program stored in a ROM 303 into a RAM 302 and executing the program, for example.

The RAM 302 is used to load the program executed by the CPU 301, and to temporarily store data that is processed by the CPU 301, data that is currently processed, and so forth. Furthermore, the RAM 302 may be used as a buffer for video signals obtained through image capture.

The ROM 308 is a nonvolatile rewritable memory. The ROM 308 stores the program executed by the CPU 301, setting values of the overhead camera 300, user data, and so forth. Note that the ROM 308 can also be used as a recording destination of video signals. The ROM 308 may include a built-in memory and an attachable/removable memory card.

An image sensor 307 includes an image capture optical system and an image sensor. The image sensor may be a known CCD or CMOS color image sensor that includes, for example, color filters based on the primary-color Bayer arrangement. The image sensor includes a pixel array in which a plurality of pixels are two-dimensionally arrayed, and peripheral circuits for reading out signals from each pixel. Each pixel accumulates charges corresponding to the amount of incident light by way of photoelectric conversion. Signals with a voltage corresponding to the amount of charges accumulated in an exposure period are read out from each pixel; as a result, a group of pixel signals (analog image signals) representing a subject image formed on an image plane is obtained.

An image processing unit 306 applies predetermined signal processing and image processing to the analog image signals output from the image sensor 307, thereby generating signals and image data that suit an intended use, and obtaining and/or generating various types of information.

The processing applied by the image processing unit 306 can include, for example, preprocessing, color interpolation processing, correction processing, detection processing, data editing processing, evaluation value calculation processing, special effects processing, and so forth.

The preprocessing can include A/D conversion, signal amplification, reference level adjustment, defective pixel correction, and so forth.

The color interpolation processing is processing which is executed in a case where the image sensor 307 includes color filters, and in which the values of color components that are not included in the individual pieces of pixel data that compose image data are interpolated. The color interpolation processing is also called demosaicing processing.

The correction processing can include such processing as white balance adjustment, tone correction, correction of image deterioration caused by optical aberration of the image capture optical system (image recovery), correction of the influence of vignetting of the image capture optical system, and color correction.

The data editing processing can include such processing as cutout of a region (cropping), composition, scaling, encoding and decoding, and generation of header information (generation of a data file). The data editing processing also includes generation of video signals to be output to the outside, and video data to be recorded into the ROM 308.

The evaluation value calculation processing can include such processing as generation of signals and evaluation values used in automatic focus detection (AF), and generation of evaluation values used in automatic exposure control (AE). The CPU 301 executes AF and AE.

The special effects processing can include such processing as addition of blur effects, alteration of shades of colors, relighting, and so forth.

Note that these are examples of processing that can be applied by the image processing unit 306, and are not intended to limit processing applied by the image processing unit 306.

The image processing unit 306 outputs information and data that have been obtained or generated to the CPU 301, the RAM 302, and the like in accordance with an intended use.

Note that the types and settings of processing applied by the image processing unit 306 can be controlled by transmitting commands from the capture control apparatus 100 to the overhead camera 300.

A network I/F 305 is an interface for connecting the overhead camera 300 to the communication network 700. The overhead camera 300 (CPU 301) can communicate with external apparatuses in the communication network 700, such as the capture control apparatus 100, the sub camera 400, the main camera 500, and the role control apparatus 600, via the network I/F 305. Note that the overhead camera 300 may communicate with external apparatuses via another non-illustrated communication interface (a USB, Bluetooth, or the like).

### (Camera 400)

Next, an exemplary functional configuration of the camera 400 will be described. As stated earlier, the cameras 400 and 500 may be configured in the same manner. Therefore, the configuration of the camera 400 will be described as a representative. Note that in the present specification, it is assumed that reference numerals 501 to 510 indicate constituent elements of the camera 500 that correspond to constituent elements 401 to 410 of the camera 400. It is assumed that, among constituent elements of the camera 400, functional blocks that have the same names as those of the camera 300 have the same functions thereas, and a description thereof is omitted.

The camera 400 is a camera whose capture direction (pan and tilt angles) and angle of view (zoom value) can be remotely controlled. Therefore, the camera 400 includes a driving unit 409 that can perform pan and tilt performances and a zoom performance, and a driving I/F 408. The driving I/F 408 is a communication interface between the driving unit 409 and a CPU 401.

The driving unit 409 includes a pan/tilt mechanism by which the sub camera 400 is supported so that it can be panned and tilted, a zoom mechanism that changes the angle of view of the image capture optical system, a motor that drives these mechanisms, and the like. Enlargement and reduction of images performed by an image processing unit 406 may be used in the zoom mechanism. The driving unit 409 drives the motor in accordance with instructions received from the CPU 401 via the driving I/F 408, and adjusts the optical axis direction (capture direction) and the angle of view of the image capture optical system. Note that the pan/tilt mechanism included in the driving unit 409 may be an electric camera platform on which the camera 400 is mounted.

The CPU 401 controls the pan/tilt mechanism of the driving unit 409 via the driving I/F 408 in accordance with a pan and/or tilt command received via a network I/F 405. Also, the CPU 401 controls the zoom mechanism of the driving unit 409 via the driving I/F 408 in accordance with a zoom command received via the network I/F 405.

The capture control apparatus 100 (CPU 101) can obtain information of the capture directions and the angles of view of the cameras 400 and 500 from the cameras 400 and 500 via the network I/F 105. Note that the capture directions may be the pan and tilt angles of the driving units 409 and 509 based on a preset reference direction of 0°. The reference direction may be a direction directly facing a captured area.

The cameras 400 and 500 output captured videos to a non-illustrated external apparatus, such as a switcher. The switcher selects and outputs one of the videos from the cameras 400 and 500.

Furthermore, the cameras 400 and 500 output videos for live-view display to the capture control apparatus 100 and the remote control apparatus 800, separately from the videos output to the switcher. Note that in a case where the cameras 400 and 500 are configured to perform depending on whether they are set as a main camera or a sub camera, it is sufficient that only the main camera outputs a video for live-view display to the remote control apparatus 800.

### (Role Control Apparatus 600)

Next, a functional configuration of the role control apparatus 600 will be described.

A CPU 601 is a microprocessor capable of executing programmed instructions. The CPU 601 controls the operations of each functional block and realizes the functions of the role control apparatus 600 by reading a role setting program stored in a ROM 603 into a RAM 602 and executing the role setting program, for example.

The RAM 602 is used to load the program executed by the CPU 601, and to temporarily store data that is processed by the CPU 601, data that is currently processed, and so forth. Also, a part of the RAM 602 may be used as a video memory for a display unit 608.

The ROM 603 is a nonvolatile rewritable memory, and stores the program executed by the CPU 601, setting values of the role control apparatus 600, user data, and so forth.

A user input unit 611 is an input device, such as a button, a dial, a joystick, and a touch panel, for example. The role control apparatus 600 accepts a user instruction related to the role setting on the sub camera 400 via the user input unit 611.

A network I/F 605 is an interface for connecting the role control apparatus 600 to the communication network 700. The role control apparatus 600 (CPU 601) can communicate with external apparatuses in the communication network 700, such as the overhead camera 300, the sub camera 400, and the capture control apparatus 100, via the network I/F 605. Note that the role control apparatus 600 may communicate with external apparatuses via another non-illustrated communication interface (a USB, Bluetooth, or the like).

The display unit 608 is a display apparatus, such as a liquid crystal display (LCD). The display unit 608 displays a GUI screen provided by an OS, a role setting application, or the like.

The role control apparatus 600 stores role setting information into the ROM 603, for example. The role setting information is information in which identification information of the sub camera 400 and information indicating a role that has been set are associated with each other. The CPU 601 displays a role setting screen on the display unit 608 by executing the role setting application. The role setting screen displays, for example, identification information (a network address, a name set by the user, and the like) of the sub camera 400 and the name of the role that is currently set in association with each other. An initial value of the role that is currently set may be a default role that has been set in advance. The user can change the current role displayed in association with a desired sub camera 400 by operating the user input unit 611.

Upon detection of a user operation that indicates the end of a setting operation, such as an operation on an OK button included in the role setting screen, the CPU 601 updates the role setting information stored in the ROM 103 in accordance with the content of the role setting screen.

Upon receiving a role obtainment command via the network I/F 605, the CPU 601 reads out the role setting information stored in the ROM 103, and transmits the role setting information to the transmission source of the role obtainment command.

Note that although FIG. 1 and FIG. 2 show the role control apparatus 600 as an independent apparatus, for example, the capture control application executed on the capture control apparatus 100 may provide functions similar to the functions of the role control apparatus 600. Furthermore, a role may be set directly on the sub camera 400, and the capture control apparatus 100 may obtain the role assigned to the sub camera 400 from the sub camera 400.

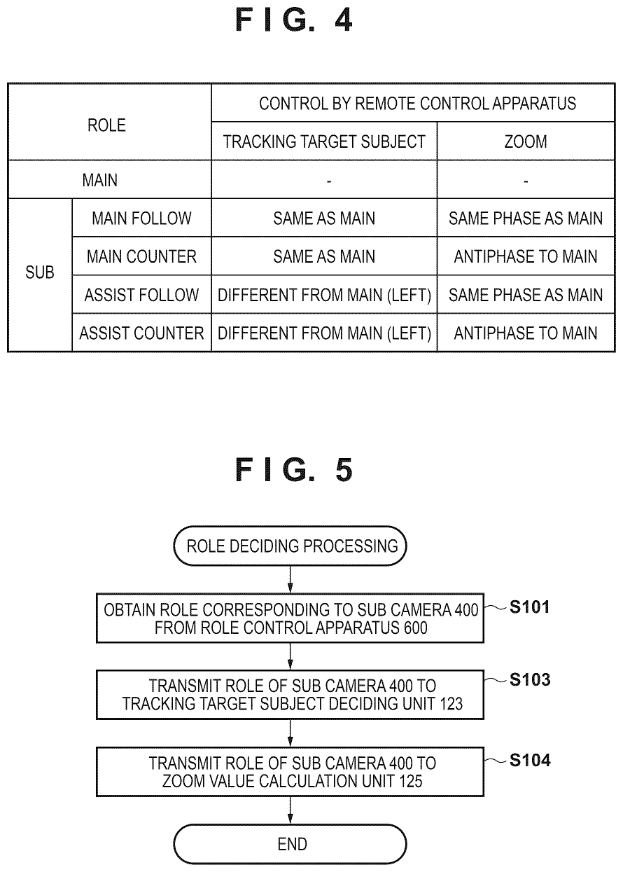

Next, with reference to FIG. 4, roles that can be set on cameras (cameras 400 and 500) other than the overhead camera 300 will be described. A role (ROLE) is information indicating whether a camera is a main camera or a sub camera, and what kind of control is performed by the capture control apparatus 100 (i.e., descriptions of automatic control) in a case where the camera is the sub camera. FIG. 4 shows an example of a case where the capture control apparatus 100 controls a tracking target subject and a zoom performance of the sub camera. However, the subject of automatic control performed by the capture control apparatus 100 is not limited to the tracking target subject and the zoom performance.

For example, a table shown in FIG. 4 can be stored in the ROM 603 of the role control apparatus 600 and the ROM 103 of the capture control apparatus 100. Note that the capture control apparatus 100 is not involved with the performance of a main camera. Therefore, only the descriptions related to the sub camera may be stored in the role control apparatus 600 and the capture control apparatus 100.

It is assumed here that one of “main follow”, “main counter”, “assist follow”, and “assist counter” can be set as a type or kind of control descriptions (CAMERA_ROLE) for a sub camera. If there are a plurality of sub cameras, the control descriptions can be set for each sub camera. Hereinafter, a sub camera for which the control descriptions of “main follow” has been set will be referred to as a camera for which a role of sub (main follow) has been set. A similar expression will be used for other control descriptions as well.

The capture control apparatus 100 and the remote control apparatus 800 treat a camera for which the role (ROLE) of “main” has been set (assumed to be the camera 500 here) as a main camera.

With respect to a camera for which the role of “sub (main follow)” has been set, the capture control apparatus 100 (CPU 101) sets the same tracking target subject as the main camera. Also, in a case where the angle of view of the main camera has been changed, the capture control apparatus 100 applies zoom control that is in phase with the main camera to the camera to be controlled. Here, in-phase means that the zoom direction (telephoto direction or wide-angle direction) is the same, that is to say, the direction of change in the angle of view is the same. Therefore, when zoom-in of the main camera has been detected, the capture control apparatus 100 performs control so that the camera to be controlled zooms in. To zoom in means to change the angle of view toward the telephoto direction (the direction toward the telephoto end).

On the other hand, antiphase means that the zoom direction (telephoto direction or wide-angle direction) is the opposite direction, that is to say, the direction of change in the angle of view is the opposite direction. Therefore, when zoom-in of the main camera has been detected, the capture control apparatus 100 performs control so that the camera to be controlled zooms out. To zoom out means to change the angle of view toward the wide-angle direction (the direction toward the wide-angle end).

Note that in zoom control of the sub camera, only the phase may be defined, and the main camera and the sub camera may not have the same angle of view. Furthermore, in both of in-phase zoom control and antiphase zoom control, the degree of change in the angle of view of the camera to be controlled (the speed of change, the rate of change, or the like) need not match the degree of change in the angle of view of the main camera.

Furthermore, in a case where zoom control is carried out by image scaling performed by the image processing unit 406, a zoom in can be realized by reducing a region to be cut out from an image and increasing the enlargement factor of the cut-out region compared to that before changing the region. Also, a zoom out can be realized by increasing increase a region to be cut out from an image and reducing the enlargement factor of the cut-out region compared to that before changing the region.

With respect to a camera for which the role of “sub (main counter)” has been set, the capture control apparatus 100 (CPU 101) sets the same tracking target subject as the main camera. Also, in a case where the angle of view of the main camera has been changed, the capture control apparatus 100 applies zoom control that is in antiphase with the main camera to the camera to be controlled.

With respect to a camera for which the role of “sub (assist follow)” has been set, the capture control apparatus 100 (CPU 101) sets a tracking target subject different from that of the main camera 500. Also, in a case where the angle of view of the main camera has been changed, the capture control apparatus 100 applies zoom control that is in phase with the main camera to the camera to be controlled.

With respect to a camera for which the role of “sub (assist counter)” has been set, the capture control apparatus 100 (CPU 101) sets a tracking target subject different from that of the main camera 500. Also, in a case where the angle of view of the main camera has been changed, the capture control apparatus 100 applies zoom control that is in antiphase with the main camera to the camera to be controlled.

Here, with respect to sub cameras for which the roles of “sub (assist follow)” and “sub (assist counter)” have been set, a subject located on the left of a subject of interest of the main camera within an image is set as a tracking target subject. Note that a tracking target subject of sub cameras for which these roles have been set may be set in accordance with another condition. For example, a subject located on the right of, above, or below a subject of interest of the main camera within an image may be set as a tracking target subject. Alternatively, a subject that is located nearest to the front or the back among subjects other than a subject of interest of the main camera may be set as a tracking target subject.

Furthermore, the capture control apparatus 100 may execute only one of setting of a tracking target subject and zoom control, or perform control under another item.

In the role setting information, which is stored into the ROM 603 by the role control apparatus 600, information indicating the role (ROLE) (e.g., the name of the type described above, or the number assigned to the type) is associated with identification information of each camera other than the overhead camera 300. The CPU 101 of the capture control apparatus 100 obtains the role setting information from the role control apparatus 600, and executes performance control corresponding to the control descriptions that have been set with respect to the respective sub cameras.

As described above, in a case where one of the setting of a main camera and the setting of the control descriptions of a sub camera has been changed, the role control apparatus 600 notifies the capture control apparatus 100 and the remote control apparatus 800 of the change. In this way, the change in the role setting can be reflected in the performance of the capture control apparatus 100 and the target of control by the remote control apparatus 800.

### (Remote Control Apparatus 800)

Next, the remote control apparatus 800 will be described. First, a functional configuration of the remote control apparatus 800 will be described with reference to FIG. 2. The remote control apparatus 800 functions as a remote controller that remotely controls a capture direction of a main camera.

The remote control apparatus 800 can be configured in such a manner that a later-described operation unit is connected to a compact general-purpose computer device, such as a tablet computer, so that they can communicate with each other. The remote control apparatus 800 is configured in such a manner that a CPU 801, a RAM 802, a ROM 803, a network interface (I/F) 805, a user input unit 811, a display unit 808, and an orientation calculation unit 807 are mutually connected via an internal bus 810.

The CPU 801 is a microprocessor capable of executing programmed commands. The CPU 801 realizes later-described functions of the remote control apparatus 800 by, for example, reading in a program stored in the ROM 803 into the RAM 802 and executing the program. The CPU 801 can realize the functions of the remote control apparatus 800 by, for example, executing a capture control application that operates on fundamental software (OS).

The RAM 802 is used to load the program executed by the CPU 801, and to temporarily store data to be processed by the CPU 801, data that is currently processed, and so forth. Also, a part of the RAM 802 may be used as a video memory for the display unit 808.

The ROM 803 is a nonvolatile rewritable memory, and stores the program (OS and application) executed by the CPU 801, user data, and so forth.

The network I/F 805 is an interface for connecting the remote control apparatus 800 to the communication network 700. The remote control apparatus 800 (CPU 801) can communicate with external apparatuses in the communication network 700, such as the cameras 300 to 500, the role control apparatus 600, and the capture control apparatus 100, via the network I/F 805. Note that the remote control apparatus 800 may communicate with any external apparatuses, including each apparatus shown in FIG. 2, via another non-illustrated communication interface (a USB or Bluetooth®).

The CPU 801 receives information (e.g., an IP address) that specifies a camera for which the role of “main” has been set (a main camera) from the role control apparatus 600 via the network I/F 805. Thereafter, the CPU 801 remotely controls the capture direction and the angle of view of the main camera via the capture control apparatus 100 by transmitting the orientation and the operation amount of an operation unit 812 to the capture control apparatus 100. Note that the performance of the main camera other than the capture direction and the angle of view (e.g., starting and stopping of image capture, ON and OFF of a power source, a change in various types of settings, and the like) may also be remotely controlled by the remote control apparatus 800 via the capture control apparatus 100.

The user input unit 811 is an input device, such as a mouse, a keyboard, and a touch panel. The CPU 801 accepts a user instruction via the user input unit 811.

The display unit 808 is a display apparatus, such as a liquid crystal display (LCD). The display unit 808 displays a video (live-view video) that is currently captured by the main camera. The display unit 808 also displays a GUI screen provided by the OS, the capture control application, or the like.

In a case where the remote control apparatus 800 receives videos for live-view display from all cameras (here, the cameras 400 and 500) other than the overhead camera 300, the CPU 801 selects a video from the current main camera and displays the same on the display unit 808.

An orientation sensor 806 detects a motion of the operation unit 812, and outputs the motion to an orientation calculation unit 807. The orientation sensor 806 may be, for example, a simultaneous localization and mapping (SLAM) module, a combination of a gyroscope and an acceleration sensor, or the like. The orientation sensor 806 outputs a motion signal indicating a translational motion in each axis direction of a three-dimensional Cartesian coordinate system, including the direction of gravity, and a rotary motion around each axis to the orientation calculation unit 807.

The orientation calculation unit 807 calculates a pan angle and a tilt angle corresponding to the orientation of the operation unit 812 from the motion signal output from the orientation sensor 806. The orientation calculation unit 807 can calculate the pan angle and the tilt angle using a general self-position estimation technique. The orientation calculation unit 807 stores the calculated pan angle and tilt angle into the RAM 802 as orientation information (ORIENTATION). Note that the orientation information is not limited to the pan angle and the tilt angle, and may be any value that can specify the orientation of the operation unit 812.

The orientation calculation unit 807 calculates the pan angle and the tilt angle periodically. It is preferable that the calculation cycle be short in terms of suppression of a time lag between a motion of the operation unit 812 and a change in the orientation of the main camera. In practice, the calculation cycle can be decided in consideration of the speeds of general pan and tilt operations or movements, the resolution of the orientation sensor 806, and the driving resolution in panning and tilting of the main camera.

Once the orientation information has been stored into the RAM 802, the CPU 801 transmits the same to the capture control apparatus 100 via the network I/F 805.

In a case where the operation unit 812 includes an input device for zoom control, the CPU 801 periodically detects the operation amount and the operation direction of the input device. The detection cycle may be the same as the calculation cycle of the orientation calculation unit 807. Then, the CPU 801 calculates a zoom value (ZOOM) corresponding to the detected operation amount and operation direction, and transmits the same to the capture control apparatus 100 via the network I/F 805. Note that the CPU 801 may transmit the orientation information (ORIENTATION) and the zoom value (ZOOM) collectively to the capture control apparatus 100.

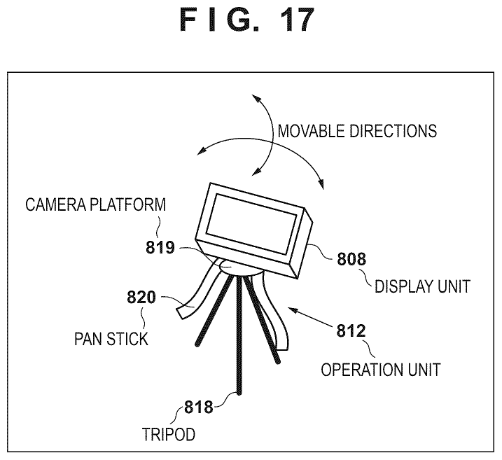

FIG. 17 is a schematic diagram showing an exemplary external view of the operation unit 812 included in the remote control apparatus 800. The operation unit 812 can include an operation unit in the form of a tripod 818 provided with a camera platform 809, which is an example of an operation member capable of executing a physical pan performance and tilt performance. The operation member can change a physical angle to a pan direction and a tilt direction, and can also maintain the angle (orientation) after the change. Note that the operation unit 812 may include an input member (e.g., a ring-shaped member or a slider switch) for controlling the angle of view of the main camera. Alternatively, a moving direction and a moving amount of the entire operation unit may be detected and used to control the angle of view.

The display unit 808 for displaying a live-view video of the main camera is attached to the operation unit 812. The display unit 808 is attached in such a manner that a screen thereof is located at the front (a pan angle of the screen becomes 0°) when, for example, the pan and tilt angles of the camera platform 809 have initial values (0°).

A user who remotely operates the main camera can perform pan and tilt operations using a pan stick 820 mounted on the camera platform 809 so that the live-view video displayed on the display unit 808 becomes a desired video, for example. In this way, the remote control apparatus 800 makes it possible to remotely control panning and tilting of the main camera with a feeling of operating the camera platform of the main camera.

Note that the above description has presented a combination of the tripod 818 and the camera platform 809 as hardware composing the operation unit 812 of the remote control apparatus 800 as a typical example. However, the configuration and the form of the operation unit is arbitrary as long as it is an operation unit whose orientation is physically operable by the user, and the orientation of the operation unit and the orientation of the main camera can be substantially placed in synchronization with each other.

Note that the orientation of the operation unit 812 and the orientation of the main camera need not necessarily be the same, and there may be a certain offset equal to or smaller than a threshold therebetween. Note that the main camera that is remotely controlled by the remote control apparatus 800 can be dynamically changed in the present embodiment. Therefore, calibration is performed so that an offset between the orientation of the operation unit 812 and the orientation of a camera in an initial state is the same for every one of the plurality of cameras which are included in the image capture system and which are other than the overhead camera 300.

### <Description of Operations of Each Apparatus>

Subsequently, the operations of each apparatus in the multi-camera image capture system will be described. It is assumed here that the capture control apparatus 100 performs automatic control on a capture operation of the sub camera 400 based on a video of the overhead camera 300, information obtained from the main camera 500, and a role set on the sub camera 400.

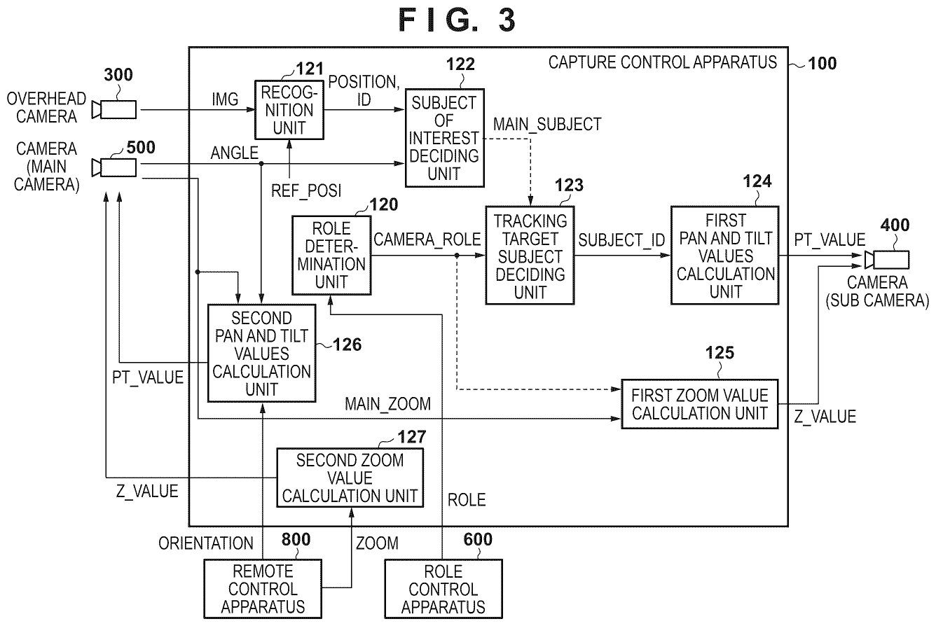

FIG. 3 is a diagram showing a processing sequence that is performed when the capture control apparatus 100 controls the operations of the sub camera 400, with a focus on main operations and flows of signals. The functional blocks shown inside the capture control apparatus 100 schematically indicate the main operations, and are equivalent to the main functions provided by the capture control application. Each functional block of FIG. 3 is realized by a combination of the CPU 101, which executes the capture control application, and one or more of the functional blocks of the capture control apparatus 100 shown in FIG. 2.

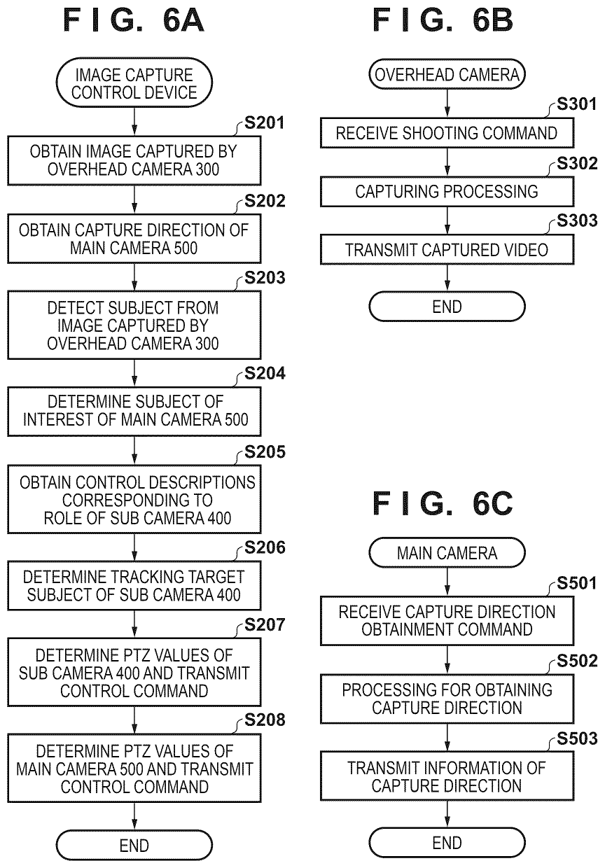

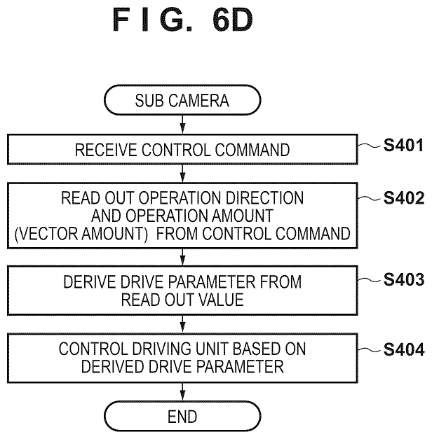

FIG. 5 is a flowchart showing the operations of the CPU 101 as a role determination unit 120. Also, FIG. 6A to FIG. 6D are flowcharts related to the operations of the capture control apparatus 100, the overhead camera 300, the main camera 500, and the sub camera 400, respectively.

In the following description, it is assumed that the capture control apparatus 100 is aware of the three-dimensional coordinate value of the viewpoint position of the overhead camera 300 and the capture direction (the optical axis direction) thereof. Furthermore, it is assumed that known position information, such as the three-dimensional coordinate values of the viewpoint positions of the sub camera 400 and the main camera 500, and the coordinate values of markers placed in the captured area, is stored in advance as predetermined position information REF_POSI in the ROM 103. Note, it is assumed that the coordinate system of a position is determined in advance in accordance with the type of the position.

### (Operations of Role Determination Unit 120)

First, the operations of the CPU 101 as the role determination unit 120 of FIG. 3 will be described with reference to the flowchart shown in FIG. 5. The operations described below are realized by the CPU 101 executing the capture control application.

Note that although the timing to start the operations shown in the flowchart of FIG. 5 is not limited in particular, the operations are executed at least before the start of control on the capture operation of the sub camera 400. Furthermore, it is assumed that the operations are also executed upon receiving a notification indicating that the role setting on the sub camera 400 has been changed from the role control apparatus 600 via the network I/F 105.

In step S101, the CPU 101 as the role determination unit 120 obtains a role (ROLE) corresponding to the sub camera 400 (role setting information) from the role control apparatus 600. The CPU 101 can obtain the above-described role setting information from the role control apparatus 600 by, for example, transmitting a role obtainment command to the role control apparatus 600 via the network I/F 105. The CPU 101 stores the obtained role setting information into the RAM 102.

In step S103, the CPU 101 refers to the role setting information stored in the RAM 102 based on identification information of the sub camera 400, and obtains the descriptions of operational control on the sub camera 400. Then, the CPU 101 as the role determination unit 120 transmits the obtained descriptions of operational control (CAMERA_ROLE) to a tracking target subject determination unit 123. In practice, the CPU 101 stores the descriptions of operational control into a specific region of the RAM 102, and refers to the same when it functions as the tracking target subject determination unit 123.

In step S104, the CPU 101 as the role determination unit 120 transmits the obtained descriptions of operational control (CAMERA_ROLE) to a zoom value calculation unit 125. In practice, the CPU 101 stores the descriptions of operational control into a specific region of the RAM 102, and refers to the same when it functions as the zoom value calculation unit 125.

### (Operations of Capture Control Apparatus 100)

Next, the operations of the capture control apparatus 100 to control image capture performed by the sub camera 400 will be described with reference to FIG. 3 and FIG. 6A. The operations described below are equivalent to the operations of the CPU 101 as a recognition unit 121, a subject of interest determination unit 122, a tracking target subject determination unit 123, a pan/tilt value calculation unit 124, and a zoom value calculation unit 125 of FIG. 3. Note that the operations described below are realized by the CPU 101 executing the capture control application.

In step S201, the CPU 101 transmits a capture instruction command to the overhead camera 300 via the network I/F 105 using a predetermined protocol. In response to this command, the overhead camera 300 starts to supply video signals (moving image data) IMG to the network I/F 105. The CPU 101 starts to store the video signals received by the network I/F 105 into the RAM 102, and then executes step S202.

In step S202, the CPU 101 obtains information ANGLE indicating a capture direction from the main camera 500. Specifically, the CPU 101 transmits a capture direction obtainment command to the main camera 500 via the network I/F 105 using a predetermined protocol. In response to the capture direction obtainment command, a CPU 501 of the main camera 500 transmits information ANGLE indicating the current capture direction of the main camera 500 to the capture control apparatus 100. The information ANGLE may be, for example, the pan and tilt angles of the driving unit 509. The CPU 101 stores the obtained information ANGLE into the RAM 102.

In step S203, the recognition unit 121 executes the following processing.
(1) Apply processing for detecting subject regions to an input frame image, and store the detection results.
(2) For each of the detected subject regions, apply coordinate transformation to position information (image coordinates).
(3) For each of the detected subject regions, apply identification processing and specify identification information (in the case of a new subject, add information for identification processing).
(4) For each of the detected subject regions, store identification information ID[n] and position information POSITION[n] in association with each other.

The recognition unit 121 is realized mainly by the CPU 101 and the inference unit 104. The CPU 101 reads out, from the RAM 102, one frame of the video received from the overhead camera 300, and inputs the frame to the inference unit 104.

The following describes the operations of the recognition unit 121 in order.
(1) First, the inference unit 104 inputs the frame image to the machine learning model, and detects subject regions. The inference unit 104 stores the positions and the sizes of the respective subject regions that have been detected and the detection reliability degrees thereof, which have been output by the machine learning model as detection results, into the RAM 102. A position and a size of a subject region may be any information that allows a position and a size of a rectangular region in which the subject region is inscribed to be specified. Here, the central coordinates of the lower edge of the rectangular region, and the width and the height of the rectangular region, are used as the position and the size of the subject region.

Also, the inference unit 104 stores the detection results for the first frame image into the RAM 102 in association with identification information pieces ID[n] of subjects. Here, n is a subject number, and is an integer that takes a value from one to the total number of detected subject regions. Furthermore, the inference unit 104 stores the subject regions detected from the first frame image as templates for identifying the individual subjects into the RAM 102 in association with the identification information pieces ID[n] of the subjects. In a case where template matching is not used in identification of subjects, the templates may not be stored.

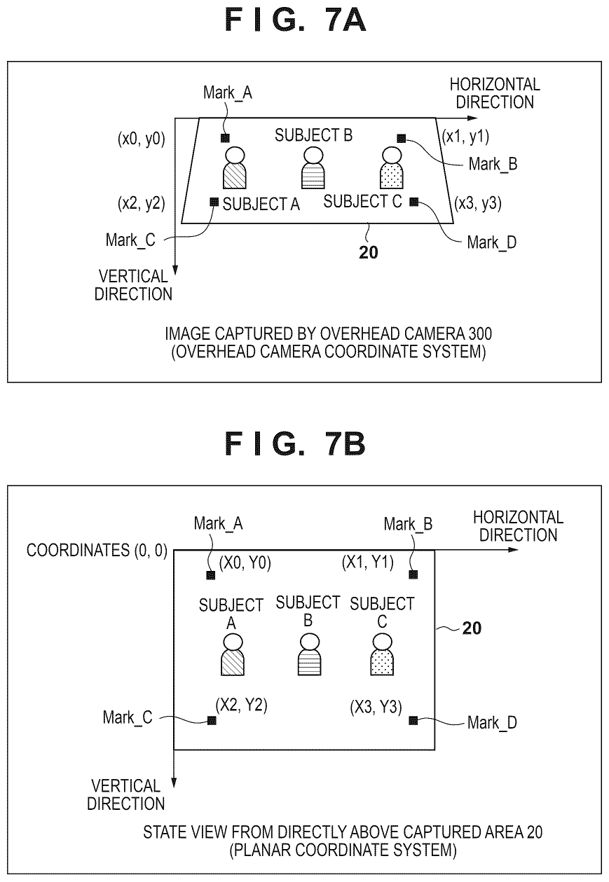

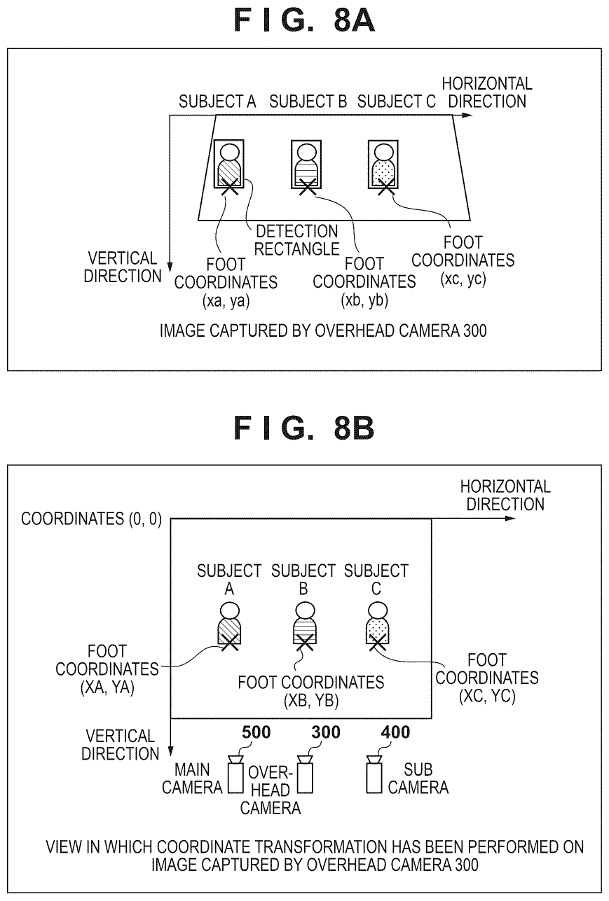

FIG. 8A shows examples of the results of subject detection processing that has been executed by the inference unit 104 with respect to a video of the overhead camera 300 shown in FIG. 7A. Here, the regions of human subjects A to C, who are present inside a captured area 20, are detected, and the coordinates of the centers of the lower edges of rectangular regions in which the subject regions are inscribed (foot coordinates) are output as positions.

Note, for example, in a case where markers (Marks) are placed at known positions inside the captured area 20 as shown in FIG. 7B for the purpose of later-described coordinate transformation, the CPU 101 detects images of the markers included in the frame image (FIG. 7A), and stores the positions thereof into the RAM 102. The inference unit 104 may be configured to execute the detection of marker images as well. The detection of marker images can be carried out using any known method, such as pattern matching that uses marker templates. Marker images may be detected using a pre-stored machine learning model intended for marker detection.
(2) Next, the coordinate transformation executed by the inference unit 104 will be described. FIG. 7A schematically shows a video of the overhead camera 300, and FIG. 7B schematically shows a state where the captured area 20 is viewed from directly above the center thereof. The inference unit 104 transforms the coordinates of the positions of the subject regions in a coordinate system of the overhead camera into the values of a coordinate system (planar coordinate system) of a case where the captured area 20 is viewed from directly above the center thereof.

Here, the reason why the coordinates are transformed into the values of the planar coordinate system is because the coordinate transformation is convenient for calculation of a pan value for causing the sub camera 400 to capture a specific subject (an angle of movement on a horizontal plane). Note that the present description is provided on the premise that the sub camera 400 is placed so that the driving unit 409 performs a pan operation on a horizontal plane parallel to the floor of the captured area 20.

The coordinate transformation can be executed using a variety of methods; here, markers are placed at a plurality of known positions on the floor of the captured area 20, and the coordinates of the overhead camera coordinate system are transformed into the coordinates of the planar coordinate system based on the marker positions inside the video obtained from the overhead camera 300. Note that the coordinate transformation may be performed with use of, for example, the viewpoint position and the capture direction of the overhead camera 300, without using markers.

The coordinate transformation can be executed using a homography transformation matrix H in accordance with the following formula 1.

$$( \begin{matrix}X \\ Y \\ W\end{matrix} ) = H ( \begin{matrix}x \\ y \\ 1\end{matrix} ) \qquad ( formula 1 )$$

In formula 1, x and y on the right side are the horizontal coordinate and the vertical coordinate in the overhead camera coordinate system, whereas X and Y on the left side are the horizontal coordinate and the vertical coordinate in the planar coordinate system.

The homography transformation matrix can be calculated by solving simultaneous equations by assigning the coordinates of the four markers detected from the video and the (known) coordinates of the four markers placed in the captured area 20 in formula 1. In a case where the positional relationship between the captured area 20 and the overhead camera 300 is fixed, the homography transformation matrix H can be calculated in advance at the time of test image capture and stored into the ROM 103, for example.

The CPU 101 sequentially reads out the positions of the subject regions from the RAM 102, and transforms the coordinates thereof into the values of the planar coordinate system. FIG. 8B schematically shows a state where the foot coordinates (x, y) of each subject region detected from the video of the overhead camera 300 shown in FIG. 8A have been transformed into the coordinate values (X, Y) of the planar coordinate system with use of formula 1 and the homography transformation matrix H stored in the ROM 103. The CPU 101 stores the foot coordinates obtained through the coordinate transformation as POSITION [n] into the RAM 102.
(3) Next, a description is given of an operation of the inference unit 104 to specify the identification information pieces ID[n] of the subjects. It is assumed here that the subjects are identified using template matching. Subject identification is carried out with respect to the results of subject detection processing that has been executed for the second time onward. With respect to the results of processing that has been executed for the first time, it is sufficient to newly assign identification information pieces ID[n] to the subject regions.

The inference unit 104 specifies identification information pieces ID[n] of the detected subject regions by way of template matching that uses templates stored in the RAM 102. As a result, the subjects inside the captured area are identified. For example, for each of the detected subject regions, the inference unit 104 calculates evaluation values indicating correlations with the individual templates. Then, the inference unit 104 specifies identification information ID[n] corresponding to a template with which it has a correlation equal to or larger than a certain level and it has the highest correlation as identification information ID[n] of the subject region. For example, a known value, such as the sum of absolute differences between pixel values, can be used as an evaluation value.

Note, with respect to a subject region that does not have a correlation equal to or larger than the certain level with any template, the inference unit 104 assigns new identification information ID[n] and adds an image of the subject region as a template.

Also, the inference unit 104 may update existing templates using the subject regions that have been detected in the latest frame image, and may delete a template if a subject region that has a correlation equal to or larger than the certain level therewith does not exist for a certain period. Furthermore, the inference unit 104 may store templates corresponding to identification information pieces ID[n] that frequently appear into the ROM 103.

Note that the subjects may be identified using a method other than template matching. For example, the same identification information ID[n] may be specified for a subject region that is closest, in terms of at least one of the detected position and the size, to an immediately-preceding subject region. Also, a position in the current frame image may be predicted using a Kalman filter or the like based on positional transitions in the plurality of past detection results associated with the same identification information, and the same identification information ID may be specified for a subject region that is closest to the predicted position. Furthermore, these methods may be combined. When template matching is not used, the accuracy of identification of different subjects with similar appearances can be increased.
(4) The inference unit 104 stores the specified identification information pieces ID[n] and the positions (planar coordinate system) POSITION [n] of the corresponding subject regions into the RAM 102 in association with each other.

Note that among the processing of (1) to (4), processing other than the subject detection may be executed by the CPU 101 in place of the inference unit 104.

Here, the identification information pieces ID[n] and the positions POSITION [n] related to the subjects inside the captured area 20 are obtained using the video of the overhead camera 300. However, a video of the sub camera 400 may be used. In a case where there are a plurality of sub cameras 400, the CPU 101 executes the operations shown in the flowchart of FIG. 6A for each sub camera 400. The positions of subject regions are output as values of a coordinate system of each sub camera 400. In this way, the overhead camera 300 is not indispensable, but it is considered that the accuracy of subject detection is higher when the overhead camera 300 is used.

Returning to the description of FIG. 6A, in step S204, the CPU 101 as the subject of interest determination unit 122 of FIG. 3 determines a subject of interest that acts as a tracking target subject of the main camera 500. The CPU 101 can determine the subject of interest of the main camera 500 among the subjects detected in step S203 based on the capture direction of the main camera 500 obtained in step S202. The CPU 101 stores the identification information ID[n] corresponding to the subject region that has been determined as the subject of interest of the main camera 500 as identification information MAIN_SUBJECT of the subject of interest into the RAM 102.

For example, the CPU 101 can determine a subject that is closest to the capture direction of the main camera 500 in the planar coordinate system as the subject of interest of the main camera 500. Note that in a case where there are a plurality of subjects that are at a distance equal to or smaller than a threshold from the capture direction of the main camera 500, the user may select the subject of interest from among such subjects.

In a case where the user selects the subject of interest, the CPU 101 causes the display unit 108 or an external display apparatus to display the frame image to which the subject detection processing has been applied in step S202, together with an indicator that indicates the capture direction and indicators that indicate subject regions that are candidates for the subject of interest. The indicators of the subject regions may be, for example, rectangular frames indicating the outer edges of the subject regions shown in FIG. 8A, or may be other indicators. Furthermore, the CPU 101 may cause the display unit 108 to also display, for example, a message for encouraging a selection of a subject of interest inside the image.

The user can select a subject region corresponding to a desired subject of interest by operating the user input unit 106 (input device). The selection method is not limited in particular, but may be an operation of designating a desired subject region by operating a mouse or a keyboard.

Upon detecting a user operation for designating a subject region, the CPU 101 stores the identification information ID[n] corresponding to the designated subject region as identification information MAIN_SUBJECT of the subject of interest into the RAM 102.

Next, in step S205, the CPU 101 as the tracking target subject determination unit 123 of FIG. 3 obtains control descriptions CAMERA_ROLE corresponding to the role set on the sub camera 400. Specifically, the CPU 101 reads out control descriptions CAMERA_ROLE that has been obtained in the role determination processing, which has been described using FIG. 5, and stored in the RAM 102. Note that in a case where there are a plurality of sub cameras 400, the CPU 101 executes the processing of steps S205 to S207 for each sub camera.

In step S206, the CPU 101 as the tracking target subject determination unit 123 determines a subject to be tracked and captured by the sub camera 400 in accordance with the control descriptions CAMERA_ROLE. The CPU 101 determines a tracking target subject of the sub camera 400 in accordance with the provision related to the tracking target subject included in the control descriptions CAMERA_ROLE (FIG. 4).

In a case where the sub camera 400 is to have a tracking target subject that is the same as the subject of interest of the main camera 500, the CPU 101 sets the identification information MAIN_SUBJECT of the subject of interest that has been determined in step S203 as identification information SUBJECT_ID of the tracking target subject of the sub camera 400.

In a case where a subject located on the left side among the subjects other than the subject of interest of the main camera 500 is to be set as the tracking target subject of the sub camera 400, the CPU 101 detects, among the subject regions detected in step S203, a leftmost subject region among the subject regions other than the subject of interest. Then, the CPU 101 sets the identification information ID[n] corresponding to the detected subject region as identification information SUBJECT_ID of the tracking target subject of the sub camera 400.

The CPU 101 writes the identification information SUBJECT_ID of the determined tracking target subject to the RAM 102. In a case where the tracking target subject can differ among the sub cameras, the CPU 101 stores the identification information pieces SUBJECT_ID of the tracking target subjects in association with the identification information pieces of the sub cameras. Note that in a case where the tracking target subject has changed, the CPU 101 keeps holding information of the previous tracking target subject in the RAM 102 without deleting the same.

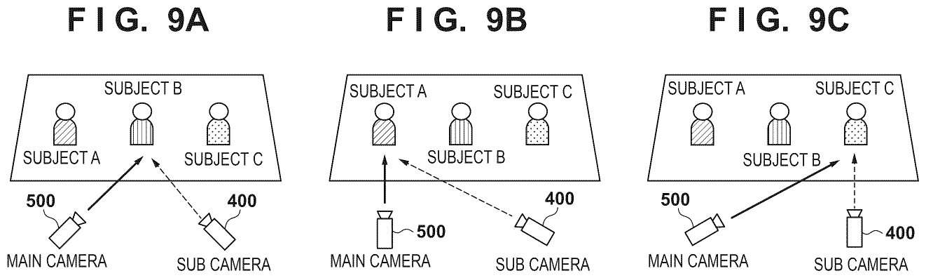

Using FIGS. 9A to 9C, the following describes the operations for a case where the role set on the sub camera 400 is “main follow”. With regard to the sub camera 400 on which the role “main follow” is set, the capture control apparatus 100 performs control to track a subject of interest of the main camera 500.

Therefore, in a case where the subject of interest of the main camera 500 has been determined to be the subject B as shown in FIG. 9A, the CPU 101 determines the subject B as a tracking target subject of the sub camera 400. Thereafter, in a case where it has been determined that the subject of interest of the main camera 500 has been changed to the subject A as shown in FIG. 9B, the CPU 101 changes the tracking target subject of the sub camera 400 to the subject A. Similarly, in a case where it has been determined that the subject of interest of the main camera 500 has been changed to the subject C as shown in FIG. 9C, the CPU 101 changes the tracking target subject of the sub camera 400 to the subject C.

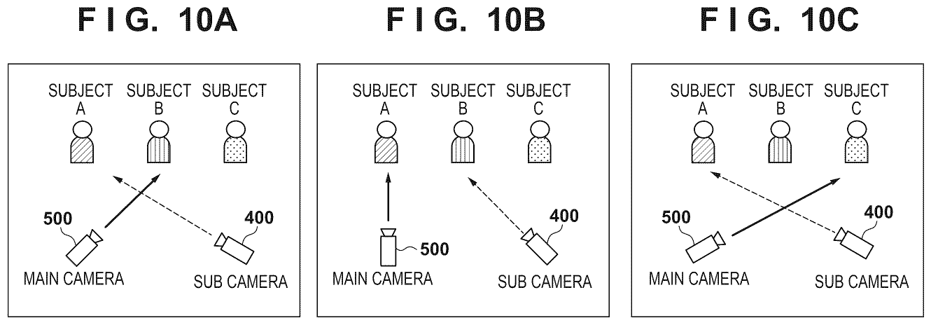

Using FIGS. 10A to 10C, the following describes the operations for a case where the role set on the sub camera 400 is “assist follow”. With regard to the sub camera 400 on which the role “assist follow” is set, the capture control apparatus 100 performs control to track a subject located on the left side among subjects other than the subject of interest of the main camera 500.

Therefore, in a case where the subject of interest of the main camera 500 has been determined to be the subject B as shown in FIG. 10A, the CPU 101 determines the left-side subject A among the subjects A and C as a tracking target subject of the sub camera 400. Thereafter, in a case where it has been determined that the subject of interest of the main camera 500 has been changed to the subject A as shown in FIG. 10B, the CPU 101 changes the tracking target subject of the sub camera 400 to the left-side subject B among the subjects B and C. Furthermore, in a case where it has been determined that the subject of interest of the main camera 500 has been changed to the subject C as shown in FIG. 10C, the CPU 101 changes the tracking target subject of the sub camera 400 to the left-side subject A among the subjects A and B.

By dynamically changing the role set on the sub camera 400 with use of the role control apparatus 600, the tracking target subject of the sub camera 400 can be changed, and automatic image capture can be flexibly performed.

Returning to FIG. 6A, in step S207, the CPU 101 as the pan/tilt value calculation unit 124 calculates the amounts of changes in the pan angle and the tilt angle that are necessary for the sub camera 400 to track and capture the tracking target subject that has been determined in step S206. Also, the CPU 101 as the zoom value calculation unit 125 calculates a zoom value of the sub camera 400 corresponding to the change in the angle of view of the main camera 500. The following describes a case where there is one sub camera 400; however, in a case where there are a plurality of sub cameras 400, the amounts of changes in the pan angle and the tilt angle, as well as the zoom value, are calculated for each sub camera.

First, the operations of the CPU 101 as the pan/tilt value calculation unit 124 will be described. It is assumed here that the following information is stored in advance as predetermined position information REF_POSI in the ROM 103 for each sub camera 400.
Three-dimensional coordinates of the position of placement (a value in the planar coordinate system)
A capture direction corresponding to the initial values of the pan angle and the tilt angle of the driving unit
Range in which the pan and tilt angles can be controlled

The CPU 101 reads out position information POSITION_OH corresponding to identification information SUBJECT_ID of the tracking target subject of the sub camera 400 from the RAM 102. Then, the CPU 101 first determines the pan angle from the position information POSITION_OH and the position of placement of the sub camera 400.

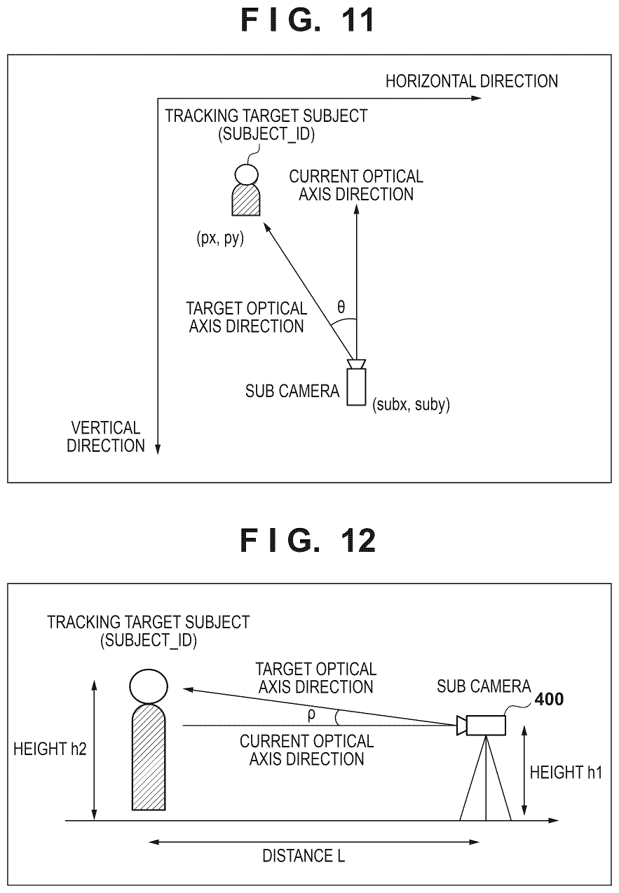

FIG. 11 is a diagram showing an example of a positional relationship between the sub camera 400 and the tracking target subject in the planar coordinate system. It is assumed here that a pan angle θ for pointing the optical axis direction of the sub camera 400 at the subject position is determined. The CPU 101 calculates the pan angle θ using the following formula 2.

$$θ = {tan}^{- 1} \frac{p s - s u b x}{p y - s u b y} ( rad ) \qquad ( formula 2 )$$

In formula 2, px and py are the horizontal coordinate and the vertical coordinate of the position information POSITION_OH corresponding to the identification information SUBJECT_ID of the tracking target subject. Also, subx and suby are the horizontal coordinate and the vertical coordinate of the position of placement of the sub camera. It is assumed here that the current pan angle is the initial value 0°, and the optical axis direction is the vertical direction (Y-axis direction). In a case where the current optical axis direction is not the vertical direction, it is sufficient to reflect the angle difference between the current optical axis direction and the vertical direction in the angle obtained from formula 2. Furthermore, the pan direction is the counterclockwise direction if subx>px, and the clockwise direction if subx<px.

Next, the method of determination on the tilt angle will be described using FIG. 12. FIG. 12 shows a state where the sub camera and the tracking target subject are viewed from the side. It is assumed that the current optical axis of the sub camera 400 extends in the horizontal direction, the height thereof is h1, and the face of the tracking target subject at which the optical axis is to be pointed is at a height of h2. It is assumed that the angle difference in the height direction between the current optical axis direction and a target optical axis direction (the tilt angle) is p. The CPU 101 calculates the tilt angle ρ using the following formula 3 and formula 4.

$$L = \sqrt{{( px - subx )}^{2} + {( py - suby )}^{2}} \qquad ( formula 3 )$$

$$ρ = {tan}^{- 1} \frac{h 2 - h 1}{L} ( rad ) \qquad ( formula 4 )$$

The coordinate values used in formula 4 are the same as the coordinate values used in formula 2. It is assumed that h1 and h2 are input to the capture control application and stored into the RAM 102 in advance. In this case, identification numbers that are associated with h2 of the respective subjects are set to be the same as identification numbers assigned in the subject detection processing. Alternatively, a value that has been measured in real time using a non-illustrated sensor may be used as h2.

It is assumed here that the current tilt angle is the initial value 0°, and the optical axis direction is the horizontal direction (the heights are constant). In a case where the current optical axis direction is not the horizontal direction, it is sufficient to reflect the angle difference between the current optical axis direction and the horizontal direction in the angle obtained from formula 4. Furthermore, the tilt direction is a downward direction if h1>h2, and an upward direction if h1<h2.

The CPU 101 cyclically communicates with the sub camera 400 via the communication network 700, obtains the current optical axis direction (the pan angle and the tilt angle of the driving unit), and stores the same into the RAM 102. Note that the communication cycle can be, for example, equal to or smaller than the reciprocal of the frame rate. Alternatively, the CPU 101 may hold the value of the sum total of the pan angles and the tilt angles that have been controlled with respect to the sub camera 400 from the initial state in the RAM 102, and use this value as the current optical axis direction.

The CPU 101 calculates the amounts of changes in the pan angle and the tilt angle of the sub camera 400 in the foregoing manner, and stores them into the RAM 102. Note that in a case where there are a plurality of sub cameras 400, the CPU 101 calculates the amounts of changes in the pan angle and the tilt angle for each sub camera.

The amounts of changes in the pan angle and the tilt angle may be an angular velocity for causing the sub camera 400 to turn to the direction of the tracking target subject. For example, the CPU 101 obtains the current pan angle and tilt angle from the sub camera 400 via the communication network 700. Then, the CPU 101 obtains a pan angular velocity proportional to the difference between the pan angle θ that has been read out from the RAM 102 and the current pan angle. Also, the CPU 101 obtains a tilt angular velocity proportional to the difference between the tilt angle ρ that has been read out from the RAM 102 and the current tilt angle. The CPU 101 stores the angular velocities calculated in the foregoing manner into the RAM 102.

Note that the amounts of changes in the pan angle and the tilt angle may be calculated using the video of the sub camera 400 instead of the video of the overhead camera 300. In this case, the CPU 101 may calculate the amount of change in the pan angle from the difference in the horizontal direction between the current optical axis direction and the direction of the tracking target subject in the coordinate system of the sub camera 400, and calculate the amount of change in the tilt angle from the difference in the vertical direction therebetween. Furthermore, in the image capture system, changing of the capture direction for tracking and capturing the tracking target subject may be performed only in one of the pan direction and the tilt direction; in such an image capture system, only the amount of change in one of the pan angle and the tilt angle may be calculated.

Next, the operations of the CPU 101 as the zoom value calculation unit 125 will be described. The CPU 101 as the zoom value calculation unit 125 cyclically obtains information MAIN_ZOOM indicating the angle of view of the main camera 500, and stores the same into the RAM 102. Then, in a case where the information MAIN_ZOOM has been changed, the CPU 101 calculates a zoom value Z_VALUE for the sub camera 400 in accordance with the control descriptions CAMERA_ROLE corresponding to the role set on the sub camera 400.

Note that the CPU 101 can determine a zoom operation of the main camera 500 and the phase thereof by, for example, detecting a change in the angle of view of the video of the main camera 500. For example, the change in the angle of view may be detected from the sizes of the subject regions, a temporal change in an interval therebetween, and the like.

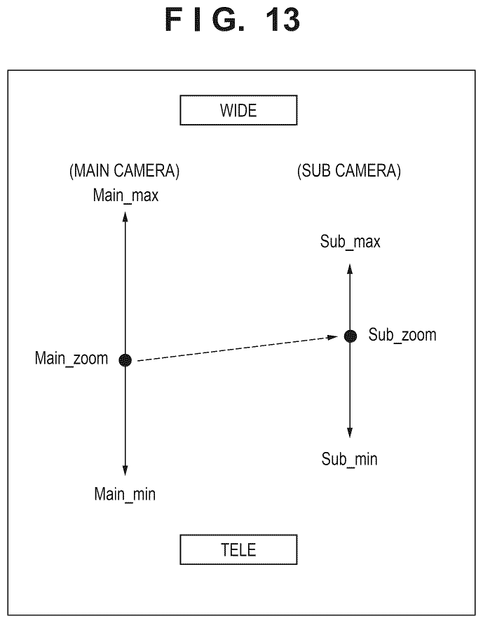

FIG. 13 shows an example of mapping of zoom values of the main camera and the sub camera. It is assumed here that the main camera 500 and the sub camera 400 optically change the angle of view (their image capture optical systems have a zoom function). However, a similar function may be realized by way of digital zooming that uses the image processing units 406 and 506.

Note that a zoom value is a parameter that has a value corresponding to the angle of view; in the present embodiment, the zoom value decreases as the angle of view decreases (narrows), and the zoom value on the telephoto side is smaller than the zoom value on the wide-angle side. It is assumed that the sub camera 400 and the main camera 500 can control their image capture optical systems to have an angle of view corresponding to a zoom value by transmitting thereto a command designating the zoom value. That is to say, a zoom value is information related to the angle of view, and is information indicating a zoom state. A zoom value may be, for example, a focal length (mm) of the image capture optical system corresponding to a full-size 35-mm image sensor; in this case, the zoom value on the telephoto side is larger than the zoom value on the wide-angle side.

In FIG. 13, the zoom value MAIN_ZOOM of the main camera 500 is in a range of main_min to main_max. Meanwhile, the sub camera 400 has a zoom range of sub_min to sub_max. Main_min and sub_min are respectively zoom values corresponding to the telephoto ends of the main camera 500 and the sub camera 400, whereas main_max and sub_max are respectively zoom values corresponding to the wide-angle ends of the main camera 500 and the sub camera 400. FIG. 13 shows an example in which the range of the zoom value of the main camera 500 is wider than the range of the zoom value of the sub camera 400, both on the telephoto end and on the wide-angle end.

In a case where the zoom value SUB_ZOOM of the sub camera 400 is controlled in phase with the zoom value MAIN_ZOOM of the main camera 500, the CPU 101 calculates SUB_ZOOM corresponding to the current MAIN_ZOOM using the following formula 5.

$$SUB\_ZOOM = \frac{MAIN\_ZOOM - main\_min}{main\_max - main\_min} \times ( sub\_max - sub\_min ) \qquad ( formula 5 )$$

On the other hand, in a case where the zoom value SUB_ZOOM of the sub camera 400 is controlled to be antiphase relative to the zoom value MAIN_ZOOM of the main camera 500, SUB_ZOOM corresponding to the current MAIN_ZOOM is calculated using the following formula 6. Specifically, the CPU 101 calculates SUB_ZOOM corresponding to the current MAIN_ZOOM by assigning SUB_ZOOM calculated from formula 5 in the right side of the following formula 6.

$$SUB\_ZOOM = sub\_max - ( SUB\_ZOOM - sub\_min ) \qquad ( formula 6 )$$

In a case where the main camera 500 performs digital zooming and controls the angle of view by way of cropping, the CPU 101 can determine on the zoom value SUB_ZOOM of the sub camera 400 in accordance with the size of the range cropped by the main camera 500. Specifically, the CPU 101 sets the zoom value SUB_ZOOM so that it decreases (achieves a higher magnification factor) as the size of the range to be cropped by the main camera 500 decreases, and sets the zoom value SUB_ZOOM so that it increases (achieves a lower magnification factor) as the size increases.

Furthermore, the zoom control associated with a role of the sub camera 400 is not limited to control that is in-phase or antiphase relative to the main camera 500. For example, a zoom operation that is independent of a change in the angle of view of the main camera 500 may be associated with a role. For example, an auto-zoom operation that maintains the tracking target subject at a constant size may be associated with a role. Furthermore, the angle of view of the sub camera 400 may be fixed at a specific angle of view. Various zoom controls can be performed with respect to the sub camera 400 by adding roles associated with the foregoing zoom controls to the control descriptions corresponding to the respective roles shown in FIG. 4, or by changing the descriptions of zoom control corresponding to the roles shown in FIG. 4.

Returning to FIG. 6A, in step S207, the CPU 101 reads out the amounts of changes in the pan and tilt angles and the zoom value, which have been calculated in step S206, from the RAM 102. Then, the CPU 101 generates a control command PT_VALUE for instructing the sub camera 400 to make changes equivalent to these amounts of changes to the pan angle and the tilt angle. Also, the CPU 101 generates a control command Z_VALUE for instructing the sub camera 400 to make a change equivalent to the zoom value to the angle of view. It is assumed that the format of the control commands has been determined in advance. The CPU 101 stores the generated control commands PT_VALUE and Z_VALUE into the RAM 102. Note that step S207 may be skipped in a case where the control commands need not be generated, such as a case where the tracking target subject is stationary and a case where the angle of view of the main camera 500 has not changed.

Then, the CPU 101 reads out the control commands PT_VALUE and Z_VALUE from the RAM 102, and transmits them to the communication network 700 via the network I/F 105. The sub camera 400 receives the control commands PT_VALUE and Z_VALUE via the network I/F 405.

In step S208, the CPU 101 decides on a PTZ value of the main camera 500 based on the orientation information (ORIENTATION) and the zoom value (ZOOM) received from the remote control apparatus 800. Then, the CPU 101 transmits a control command corresponding to the decided PTZ value to the main camera 500.

Specifically, upon receiving the orientation information (ORIENTATION) from the remote control apparatus 800, the CPU 101 that acts as a second pan and tilt values calculation unit 126 calculates the amounts of changes in the pan angle and the tilt angle based on a difference from the orientation information that was received immediately before. Then, the second pan and tilt values calculation unit 126 generates a control command PT_VALUE providing an instruction for changing the pan angle and the tilt angle in harmony with the amounts of changes. The second pan and tilt values calculation unit 126 sets the main camera (here, the camera 500) as a transmission destination of the generated control command PT_VALUE, and transmits the generated control command PT_VALUE to the communication network 700 via the network I/F 805.

Furthermore, upon receiving the zoom value (ZOOM) from the remote control apparatus 800, the CPU 101 that acts as a second zoom value calculation unit 127 calculates the amount of change in the zoom value based on a difference from the zoom value that was received immediately before. Then, based on the amount of change, the second zoom value calculation unit 127 generates a control command Z_VALUE providing an instruction for changing the zoom value. Then, the second zoom value calculation unit 127 sets the main camera (here, the camera 500) as a transmission destination of the generated control command Z_VALUE, and transmits the generated control command Z_VALUE to the communication network 700 via the network I/F 805.

The camera 500 (CPU 501) receives the control command PT_VALUE via the network I/F 505. Then, based on PT_VALUE, the CPU 501 drives the driving unit 509 via a driving I/F 508 and changes the orientation (capture direction) of the camera 500. Note that the CPU 501 may notify the capture control apparatus 100 of the changed pan angle and tilt angle.

Also, the camera 500 (CPU 501) receives the control command Z_VALUE via the network I/F 505. Then, based on Z_VALUE, the CPU 501 drives the driving unit 509 via the driving I/F 508 and changes the angle of view of the camera 500. Note that the CPU 501 may notify the capture control apparatus 100 of a zoom value corresponding to the changed angle of view.

The CPU 101 executes the processing from step S201 with respect to the next frame image in the video of the overhead camera 300. Note that the processing shown in FIG. 6A need not necessary be executed on a per-frame basis.

### (Operations of Overhead Camera 300)

Next, the operations of the overhead camera 300 will be described with reference to FIG. 6B. The operations described below are realized by the CPU 301 executing the program.

When the power of the overhead camera 300 has been turned on, the CPU 301 initializes each functional block, and then a capture standby state begins. In the capture standby state, the CPU 301 may start moving image capture processing for live-view display, and output image data for display generated by the image processing unit 306 to the capture control apparatus 100 via the network I/F 305.

In the capture standby state, the CPU 301 waits for reception of a control command via the network I/F 305. Upon receiving a control command, the CPU 301 executes operations corresponding to the control command. The following describes operations for a case where a capture command has been received as the control command from the capture control apparatus 100.

In step S301, the CPU 301 receives a capture command from the capture control apparatus 100 via the network I/F 305.

Note that in the capture command, such capture parameters as the frame rate and the resolution may be designated. Furthermore, the capture command may include settings related to processing applied by the image processing unit 306.

In step S302, in response to the reception of the capture command, the CPU 301 starts processing for capturing moving images to be supplied to the capture control apparatus 100. In this moving image capture processing, moving images that have higher image quality than those of the moving image capture processing for live-view display are captured. For example, the captured moving images are higher in at least one of the moving image resolution and the capture frame rate than moving images for live-view display. The image processing unit 306 applies processing to the images based on settings for the moving images to be supplied to the capture control apparatus 100. The image processing unit 306 sequentially stores the generated pieces of moving image data into the RAM 302.

In step S303, the CPU 101 reads out the pieces of moving image data from the RAM 302, and transmits them to the capture control apparatus 100 via the network I/F 305. From then on, processing from the image capture to the supply of pieces of moving image data is continued until a control command for stopping the image capture is received.

### (Operations of Main Camera 500)

Next, the operations of the main camera 500 will be described with reference to FIG. 6C. The operations described below are realized by the CPU 501 executing the program.

When the power of the main camera 500 has been turned on, the CPU 501 initializes each functional block, and then starts processing for capturing moving images to the supplied to the capture control apparatus 100. The image processing unit 506 applies, to analog image signals obtained from an image sensor 507, processing based on settings for the moving images to be supplied to the capture control apparatus 100. The image processing unit 506 sequentially stores the generated pieces of moving image data into the RAM 502. The CPU 501 reads out the pieces of moving image data from the RAM 502, and supplies them to the capture control apparatus 100 via the network I/F 505.

While supplying the pieces of moving image data to the capture control apparatus 100, the CPU 501 waits for reception of a control command via the network I/F 305. Upon receiving a control command, the CPU 501 executes operations corresponding to the control command. The following describes operations for a case where a capture direction obtainment command has been received. Note that in a case where a pan/tilt control command PT_VALUE or a zoom control command Z_VALUE has been received, the CPU 501 drives the driving unit 509 in accordance with the command.

In step S501, the CPU 501 receives a capture direction obtainment command via the network I/F 505. The CPU 501 stores the received capture direction obtainment command into the RAM 502.

In step S502, in response to the reception of the capture direction obtainment command, the CPU 501 obtains the current pan angle and tilt angle from the driving unit 509 via the driving I/F 508, and stores them into the RAM 502.

In step S503, the CPU 501 reads out the current pan angle and tilt angle from the RAM 502, and transmits them as information ANGLE of the capture direction to the capture control apparatus 100 via the network I/F 305.

### (Operations of Sub Camera 400)

Next, the operations of the sub camera 400 will be described with reference to FIG. 6D. The operations described below are realized by the CPU 401 executing the program.

When the power of the sub camera 400 has been turned on, the CPU 401 initializes each functional block, and then starts processing for capturing moving images to the supplied to the capture control apparatus 100. The image processing unit 406 applies, to analog image signals obtained from an image sensor 407, processing based on settings for the moving images to be supplied to the capture control apparatus 100. The image processing unit 406 sequentially stores the generated pieces of moving image data into the RAM 402. The CPU 401 reads out the pieces of moving image data from the RAM 402, and supplies them to the capture control apparatus 100 via the network I/F 405.

While supplying the pieces of moving image data to the capture control apparatus 100, the CPU 401 waits for reception of a control command via the network I/F 305. Upon receiving a control command, the CPU 401 executes operations corresponding to the control command. The following describes operations for a case where a pan/tilt control command PT_VALUE and a zoom control command Z_VALUE have been received from the capture control apparatus 100.

In step S401, the CPU 401 receives at least one of the pan/tilt control command PT_VALUE and the zoom control command Z_VALUE from the capture control apparatus 100 via the network I/F 405. The CPU 401 stores the received control command into the RAM 402.

In step S402, the CPU 401 reads out an operation direction and a corresponding operation amount (vector quantity) from the control command stored in the RAM 402, and stores them into the RAM 402. Here, in the case of the pan/tilt control command PT_VALUE, the operation direction is the direction(s) of pan and/or tilt, and the operation amount is a target angle. Meanwhile, in the case of the zoom control command Z_VALUE, the operation amount is a zoom value, and it is not necessary to read out and store the operation direction because the operation direction can be specified from the zoom value.

In step S403, the CPU 401 generates driving parameters for the driving unit 409 based on the operation direction and the operation amount that have been read out in step S403. The CPU 401 may obtain, for example, driving parameters corresponding to the combination of the operation direction and the operation amount with use of a table that has been held in the ROM 403 in advance. Note that in a case where the operation amount is provided in the form of a target value (a target angle or zoom value), the CPU 410 obtains driving parameters from the difference from the current value.

In step S404, the CPU 401 drives the driving unit 409 via the driving I/F 408 based on the driving parameters obtained in step S404. Accordingly, the driving unit 409 changes the capture direction of the sub camera 400 to the operation direction and the angle designated by the pan/tilt control command PT_VALUE. Also, the driving unit 409 changes the angle of view of the image capture optical system to the zoom value designated by the zoom control command Z_VALUE.

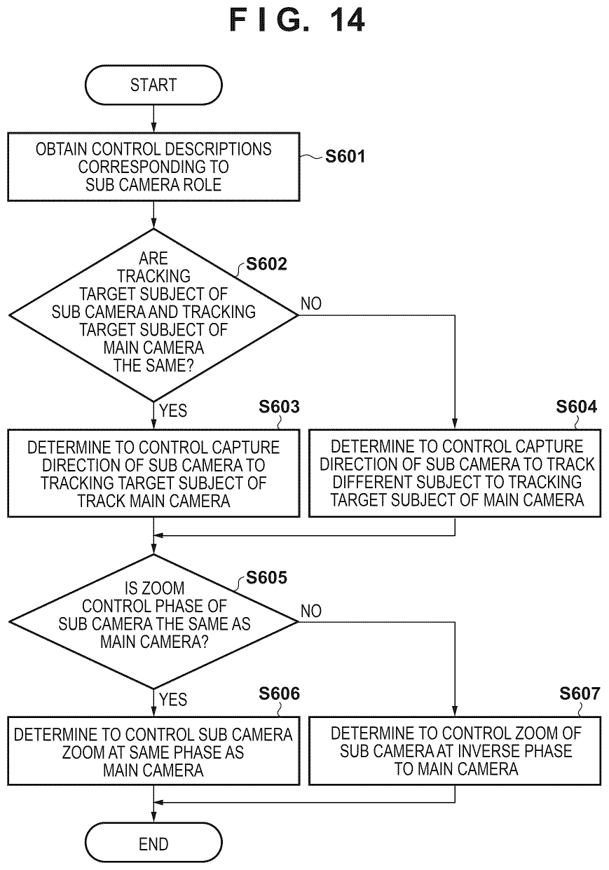

Next, the operations of the capture control apparatus 100 to control the capture direction (pan and tilt) and the angle of view (zoom value) of the sub camera in accordance with a role set on the sub camera 400 will be described in more detail using a flowchart shown in FIG. 14. The operations shown in the flowchart of FIG. 14 are executed as a part of the operations of steps S205 to S207 in FIG. 6A.

In step S601, which is equivalent to step S205, the CPU 101 reads out the control descriptions CAMERA_ROLE that have been stored into the RAM 102 in step S103 of FIG. 5.

Steps S602 to S607 are executed in, for example, step S206.

In step S602, the CPU 101 determines whether the provision related to the tracking target subject of the sub camera 400, which is included in the control descriptions CAMERA_ROLE, indicates the tracking target subject (subject of interest) of the main camera 500. For example, in a case where the provision related to the tracking target subject of the sub camera 400 has a value indicating “same as main”, the CPU 101 determines that the provision related to the tracking target subject of the sub camera 400 indicates the tracking target subject of the main camera 500, and executes step S603. On the other hand, in a case where the provision related to the tracking target subject of the sub camera 400 has a value indicating “different from main (left side)”, the CPU 101 determines that the provision related to the tracking target subject of the sub camera 400 does not indicate the tracking target subject of the main camera 500, and executes step S604.

In step S603, the CPU 101 determines to control the capture direction of the sub camera 400 so as to track the tracking target subject (subject of interest) of the main camera 500.

In step S604, the CPU 101 determines to control the capture direction of the sub camera 400 so as to track a subject located on the left side among subjects other than the subject of interest of the main camera 500.

In step S605, the CPU 101 determines whether the provision related to zoom control on the sub camera 400, which is included in the control descriptions CAMERA_ROLE, indicates control that is in phase with the main camera 500. For example, in a case where the provision related to zoom control on the sub camera 400 has a value indicating “in phase with main”, the CPU 101 determines that the provision related to zoom control on the sub camera 400 indicates control that is in phase with the main camera 500, and executes step S606. On the other hand, in a case where the provision related to zoom control on the sub camera 400 has a value indicating “antiphase relative to main”, the CPU 101 determines that the provision related to zoom control on the sub camera 400 does not indicate control that is in phase with the main camera 500, and executes step S607.

In step S606, the CPU 101 determines to control the zoom value (angle of view) of the sub camera 400 in phase with the change in the zoom value of the main camera 500.

In step S607, the CPU 101 determines to control the zoom value (angle of view) of the sub camera 400 so that the control is antiphase relative to the change in the zoom value of the main camera 500.

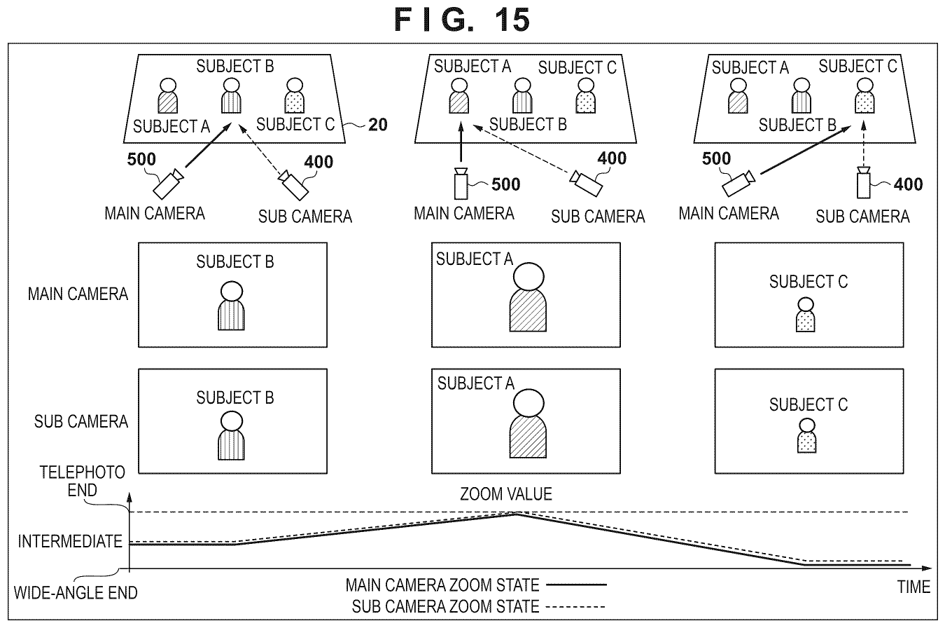

Using FIG. 15, the following describes an example of control on the sub camera for a case where the role set on the sub camera 400 is “main follow”. FIG. 15 schematically shows how the capture control apparatus 100 controls the capture direction and the angle of view of the sub camera 400 in a case where the subject of interest and the angle of view of the main camera 500 change with the passage of time during image capture. In the figure, time elapses from left to the rightward direction. Note that in FIG. 15, a zoom state is indicated in three stages: “telephoto end”, “middle”, and “wide-angle end”. This is because the range of the zoom value can differ between the sub camera and the main camera as shown in FIG. 13. “Telephoto end” corresponds to a state where the camera has zoomed in to the telephoto end, “wide-angle end” corresponds to a state where the camera has zoomed out to the wide-angle end, and “middle” corresponds to a zoom state that is in the middle between “telephoto end” and “wide-angle end”; however, an actual zoom value can differ between the sub camera and the main camera. For example, when the zoom state is “telephoto end”, the zoom value of the main camera is main_min, and the zoom value of the sub camera is sub_min.

At first, the subject of interest (tracking target subject) of the main camera 500 is the subject B, and the zoom state thereof is “middle”. Therefore, the CPU 101 determines the subject B as the tracking target subject of the sub camera 400, and controls the capture direction so that the sub camera 400 tracks the subject B. Also, the CPU 101 controls the zoom state of the sub camera 400 to be “middle”.

Thereafter, the subject of interest of the main camera 500 is changed from the subject B to the subject A, and the zoom state thereof is changed to “telephoto end”. In response, the CPU 101 changes the tracking target subject of the sub camera 400 from the subject B to the subject A, and controls the capture direction so that the sub camera 400 tracks the subject A. Furthermore, the CPU 101 controls the zoom state of the sub camera 400 to be “telephoto end”.

Thereafter, the subject of interest of the main camera 500 is changed from the subject A to the subject C, and the zoom state thereof is changed to “wide-angle end” In response, the CPU 101 changes the tracking target subject of the sub camera 400 from the subject A to the subject C, and controls the capture direction so that the sub camera 400 tracks the subject C. Furthermore, the CPU 101 controls the zoom state of the sub camera 400 to be “wide-angle end”.

As described above, in a case where the role of the sub camera 400 is “main follow”, the CPU 101 automatically changes the tracking target subject and the zoom value of the sub camera 400 so as to follow the changes in the subject of interest and the angle of view (zoom value) of the main camera 500. Note that although the extent of the change in the zoom state of the sub camera 400 is controlled to be the same as the extent of the change in the zoom state of the main camera 500 in the example shown in FIG. 15, the actual zoom values may be different as long as the directions of the changes in the zoom values are in phase with each other. For example, when the zoom state of the main camera 500 is the telephoto end, the zoom state of the sub camera 400 may not be the telephoto end. Whether to bring the zoom value of the sub camera 400 in consistency with the zoom value of the main camera 500 may be settable using the role setting information.

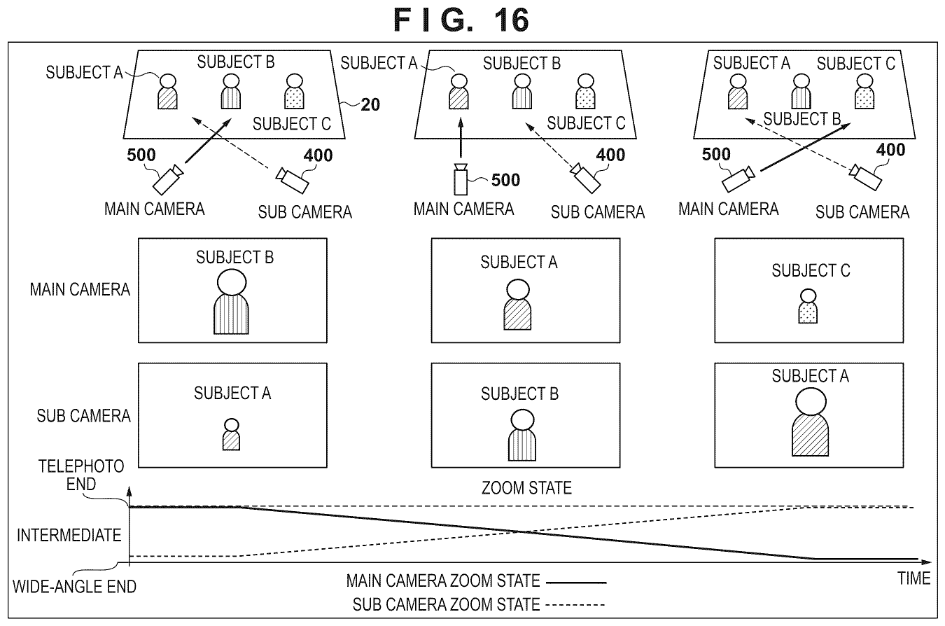

Next, an example of control on the sub camera for a case where the role set on the sub camera 400 is “assist counter” will be described using FIG. 16, which is similar to FIG. 15.

At first, the subject of interest (tracking target subject) of the main camera 500 is the subject B, and the zoom state thereof is “telephoto end”. Therefore, the CPU 101 determines the left-side subject A, among the subjects A and C other than the subject B, as the tracking target subject of the sub camera 400, and controls the capture direction so that the sub camera 400 tracks the subject A. Furthermore, the CPU 101 controls the zoom state of the sub camera 400 to be “wide-angle end”, which is antiphase relative to the main camera 500.

Thereafter, the subject of interest of the main camera 500 is changed from the subject B to the subject A, and the zoom state thereof is changed to “middle”. In response, the CPU 101 changes the tracking target subject of the sub camera 400 to the left-side subject B, among the subjects B and C other than the subject A, and controls the capture direction so that the sub camera 400 tracks the subject B. Also, as the zoom state of the main camera 500 has changed from “telephoto end” to “middle”, the CPU 101 controls the zoom state of the sub camera 400 to change from “wide-angle end” to “middle” (antiphase).

Thereafter, the subject of interest of the main camera 500 is changed from the subject A to the subject C, and the zoom state thereof is changed to “wide-angle end”. In response, the CPU 101 changes the tracking target subject of the sub camera 400 to the left-side subject A, among the subjects A and B other than the subject C, and controls the capture direction so that the sub camera 400 tracks the subject A. Also, as the zoom state of the main camera 500 has changed from “middle” to “wide-angle end”, the CPU 101 controls the zoom state of the sub camera 400 to change from “middle” to “telephoto end” (antiphase).

As described above, in a case where the role of the sub camera 400 is “assist counter”, the CPU 101 automatically changes the tracking target subject of the sub camera 400 to one of subjects other than the subject of interest of the main camera 500 in response to a change in the subject of interest of the main camera 500. Furthermore, the CPU 101 automatically changes the zoom value of the sub camera 400 in the direction opposite to the change in the angle of view (zoom value) of the main camera 500.

### (Change of Main Camera)

Next, a description is given of the performance when the setting of the main camera has been changed. Here, the description is given under the assumption that the main camera has been changed from the camera 500 to the camera 400. As stated earlier, the setting of the main camera is executed by the role control apparatus 600.

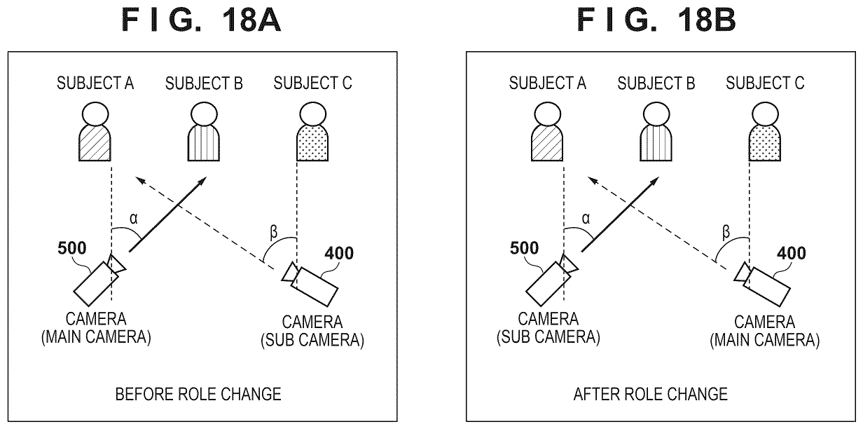

It is assumed here that the main camera has been changed from the camera 500 to the camera 400 in a state shown in FIG. 18A as an example. Also, it is assumed that the control descriptions of the camera 400 before the change are taken over as the control descriptions of the camera 500 that acts as the sub camera after the change.

In the state shown in FIG. 18A, the main camera 500 is capturing a subject B as a main subject under control of the remote control apparatus 800. Also, the control descriptions of “assist follow” is set for the sub camera 400, and the capture control apparatus 100 controls a capture direction and an angle of view thereof so as to capture a subject A as a main subject.

In this state, the main camera is changed to the camera 400, and at the same time, the sub camera is switched to the camera 500. Furthermore, the control descriptions of the camera 500 become “assist follow”. FIG. 18B shows a state immediately after the main camera has been switched.

As stated earlier, when the settings of roles of cameras have been changed, the role control apparatus 600 notifies the capture control apparatus 100 and the remote control apparatus 800 of the changed settings. Accordingly, the capture control apparatus 100 starts performance control on the sub camera in accordance with the changed settings. Also, in a case where the main camera has been changed, the capture control apparatus 100 continues performance control that was applied when the post-change or current main camera was the sub camera with respect to the post-change main camera, until a difference between the orientation of the post-change main camera and the orientation of the operation unit 812 of the remote control apparatus 800 becomes equal to or smaller than a threshold. Then, while the performance control is continued, the capture control apparatus 100 disables a remote operation on the post-change main camera by the remote control apparatus 800.

This is because, at the time of change of the main camera, the orientation of the operation unit 812 is the orientation of the pre-change main camera 500 shown in FIG. 18A, and this orientation is significantly different from the orientation of the post-change main camera 400 shown in FIG. 18B.

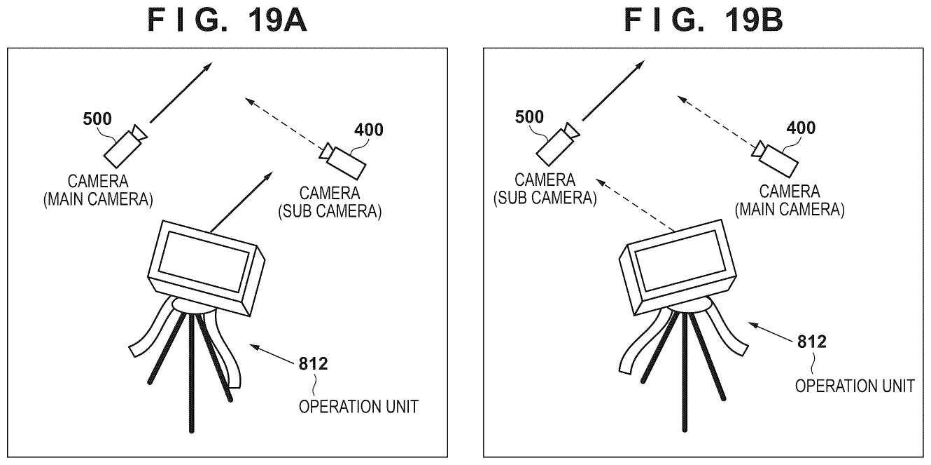

FIG. 19A shows orientations of the main camera 500 and the operation unit 812 in the state shown in FIG. 18A, and FIG. 19B shows orientations of the camera 400 and the operation unit 812 at the time of change of the main camera to the camera 400 in the state shown in FIG. 18A. As shown in FIG. 19B, at the time of change of the main camera to the camera 400, the orientation of the operation unit 812 is considerably different from the orientation of the camera 400. In this case, it is difficult to perform a remote operation on the capture direction of the camera 400 intuitively with use of the operation unit 812.

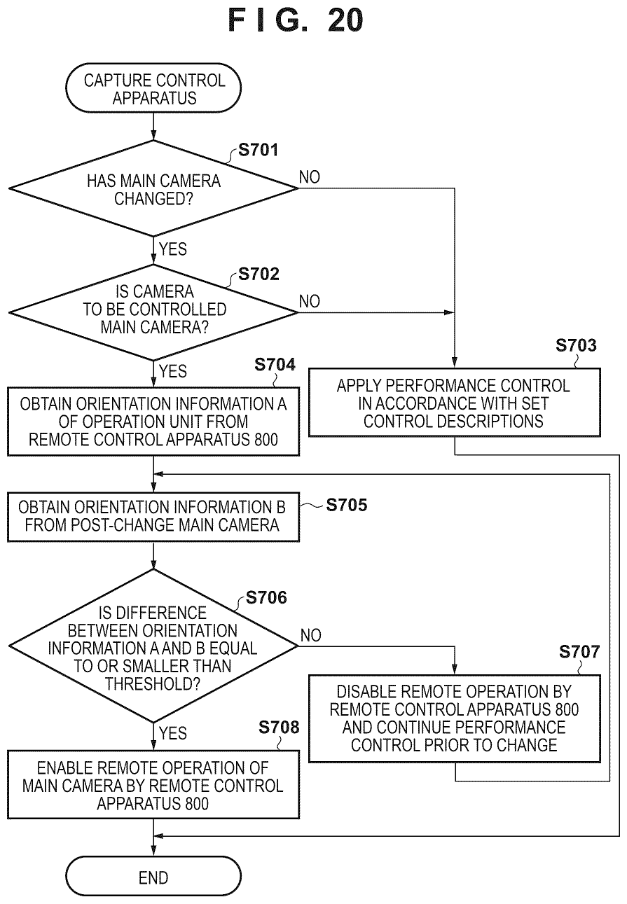

The performance of the capture control apparatus 100 when the role settings of cameras have been changed will be further described using a flowchart shown in FIG. 20. The performance described here can be executed when, for example, the role control apparatus 600 has provided a notification of the change in the settings, but may be executed at other timings.

In step S701, the CPU 101 stores role setting information notified by the role control apparatus 600 into the RAM 102, and compares the same with role setting information before the notification. Then, the CPU 101 determines whether the main camera has been changed. The CPU 101 executes step S702 if it has been determined that the main camera has been changed, and executes step S703 if it has not been thus determined.

In step S702, the CPU 101 determines whether a camera to be controlled is the main camera. The CPU 101 executes step S704 if it has been determined that the camera to be controlled is the main camera, and executes step S703 if it has not been thus determined. In a case where the main camera has been changed, the CPU 101 carries out processing of step S702 onward while setting each of the cameras other than the overhead camera 300 as a control target in sequence.

In step S703, the CPU 101 controls, as has been described using FIG. 6A, the performance of each sub camera in accordance with the set control descriptions. Thereafter, the CPU 101 continues performance control on the sub cameras until the role control apparatus 600 provides a notification of a change in settings.

In step S704, the CPU 101 obtains orientation information A of the operation unit 812 from the remote control apparatus 800.

In step S705, the CPU 101 obtains orientation information B from the post-change main camera (the camera 400 of FIG. 18B).

In step S706, the CPU 101 determines whether an absolute value of a difference between the orientation information A and the orientation information B is smaller than a threshold. Note that the orientation information A and the orientation information B can be compared as is because calibration has been performed so that the orientation of each camera is the same as the orientation of the operation unit 812 at the time of an initial setting.

In a case where orientation information is a combination of a pan angle and a tilt angle, the CPU 101 can determine whether both of the difference in the pan angle and the difference in the tilt angle are smaller than the threshold. It is desirable that the threshold be small, but the threshold need not be 0. The same threshold or different thresholds may be used for both of the pan angle and the tilt angle. In a case where different thresholds are used, the threshold for the pan angle can be larger than the threshold for the tilt angle. In this regard, in general image capture, it is rare to significantly change the tilt angle, but it is not uncommon to significantly change the pan angle; therefore, there is a high possibility that the difference in the pan angle is large at the time of change of the main camera. Thus, by making the threshold for the pan angle larger than the threshold for the tilt angle, a reduction in a period until a main camera operation in the operation unit 812 is enabled can be defined.

Also, the threshold may decrease with a decrease in the angle of view of the main camera. This is because, even if the angle difference is the same, a displacement between captured areas increases with a decrease in the angle of view. Furthermore, the threshold may increase with an increase in a motion of a subject of interest of the main camera. This is because it is desirable to reduce a period until a main camera operation in the operation unit 812 is enabled especially in a case where a motion of a subject of interest is large.

The CPU 101 executes step S708 if it has been determined that the absolute value of the difference between the orientation information A and the orientation information B is smaller than the threshold, and executes step S707 if it has not been thus determined.

In step S707, with respect to the camera 400 that has newly become the main camera, the CPU 101 continues performance control that was carried out before the camera 400 became the main camera. Note that as it is the main camera itself, an angle of view is not controlled, and a subject tracking performance is continued. Also, the CPU 101 disables a remote operation on the main camera by the remote control apparatus 800. Specifically, the CPU 101 stops the performance of the second pan and tilt values calculation unit 126 and the second zoom value calculation unit 127. Alternatively, the CPU 101 refrains from transmitting control commands generated by the second pan and tilt values calculation unit 126 and the second zoom value calculation unit 127 to the main camera. Alternatively, the CPU 101 may instruct the remote control apparatus 800 to stop transmission of orientation information and a zoom value. Then, the CPU 101 executes step S705.

For example, in a case where control is performed to place the orientation of the main camera in synchronization with the orientation of the operation unit 812, a situation can arise in which a capture direction of the main camera is abruptly changed when the main camera has been switched. However, a sudden change in the capture direction of the new main camera can be prevented by disabling the operation unit 812 in a case where a difference between the orientations of the new main camera and the operation unit 812 exceeds the threshold. Furthermore, also in a case where the orientation of the main camera is controlled in accordance with an operation amount of the operation unit 812, a decrease in operability caused by a significant shift between the orientation of the operation unit 812 and the orientation of the main camera can be suppressed.

Note that in step S707, instead of continuing the performance control that was carried out before becoming the main camera, the CPU 101 may stop the performance control and maintain the capture direction and the angle of view immediately before becoming the main camera. Alternatively, the CPU 101 may continue only control on the angle of view out of the performance control that was carried out before becoming the main camera; regarding the capture direction, the CPU 101 may maintain the capture direction immediately before becoming the main camera.

In step S708, the CPU 101 enables a remote operation on the main camera by the remote control apparatus 800. Thereafter, the CPU 101 executes the performance described using FIG. 6A.

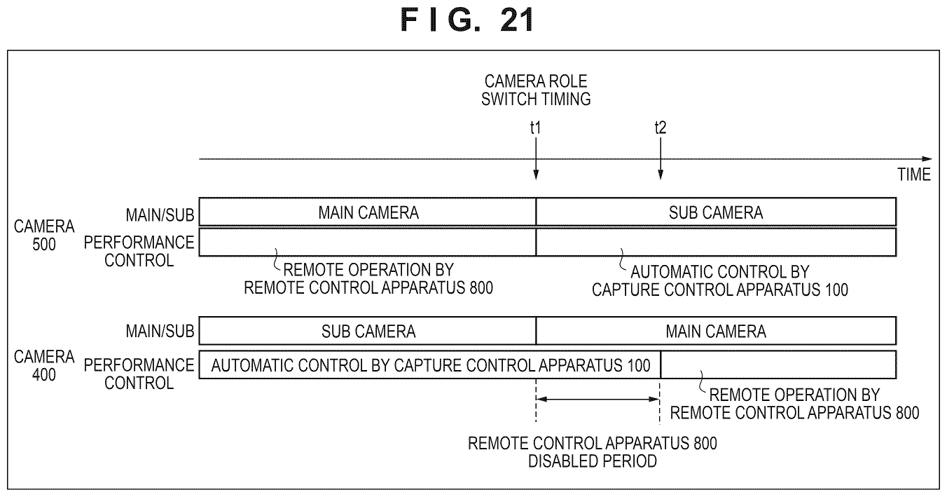

FIG. 21 is a timing chart of the performance described using FIG. 20. It is assumed here that a main camera has been changed from the camera 500 to the camera 400 at time t1. In a period before time t1, the camera 500 is set as a main camera, and a remote operation by the remote control apparatus 800 is enabled. Also, the camera 400 is set as a sub camera, and the capture control apparatus 100 performs automatic control on the camera 400 in accordance with the set control descriptions.

When the main camera has been changed from the camera 500 to the camera 400 at time t1, the camera 500 becomes a sub camera. Then, the capture control apparatus 100 starts to perform automatic control on the camera 500 in accordance with the set control descriptions. Meanwhile, although the camera 400 becomes a main camera, the capture control apparatus 100 continues automatic control for continuously tracking a subject that was tracked at the time t1 until the difference from the orientation of the operation unit 812 becomes equal to or smaller than the threshold. Also, the remote operation by the remote control apparatus 800 is disabled.

When the difference between the orientations of the camera 400 and the operation unit 812 becomes equal to or smaller than the threshold at time t2, the remote operation on the camera 400 by the remote control apparatus 800 is enabled. A period from time t1 to time t2 is a disabled period of the remote control apparatus 800.

### Modification Example

The present embodiment has been described under the assumption that the capture control apparatus 100 generates and transmits a control command for a main camera. However, the remote control apparatus 800 (CPU 801) may execute the generation and transmission of a control command for the main camera. In this case, the performance of the capture control apparatus 100 need not be changed, except that only the performance of a sub camera is controlled.

In a case where the main camera has been changed, the CPU 801 obtains an orientation of the post-change main camera, and disables the operation unit 812 in a case where a difference from an orientation of the operation unit 812 exceeds a threshold. The CPU 801 can disable the operation unit 812 by, for example, refraining from transmitting a control command to the main camera even if the operation unit 812 has been operated.

Also, when the setting of the main camera has been changed, the display unit 808 of the remote control apparatus 800 displays a live-view video of the post-change main camera 400, but there is a risk that an operator will be confused if the orientation of the operation unit 812 is not consistent with the live-view video. For this reason, in a case where the main camera has been changed, the CPU 801 may obtain an orientation of the post-change main camera, and refrain from displaying a live-view video on the display unit 808 in a period in which a difference from an orientation of the operation unit 812 exceeds the threshold.

The above description has presented an example in which, in a case where a difference between direction information A and direction information B is large, a pre-change tracking target subject is automatically tracked without using pan and tilt control values of the remote control apparatus 800. At this time, the CPU 101 may be configured not to use the obtained control values of the remote control apparatus 800; as another means, it is also possible to use a method in which the CPU 101 performs control so that pan and tilt angles are not transmitted from the remote control apparatus 800.

According to the present embodiment, an orientation of a camera that is present at a remote location is controlled to correspond to an orientation of a physical operation unit operated by a user. Therefore, the user can remotely control a capture direction of the camera with a feeling similar to that of directly operating the camera.

Furthermore, in a case where a camera to be remotely controlled has been changed, remote control is disabled until a difference between an orientation of an operation unit and an orientation of a camera to be newly remotely controlled becomes equal to or smaller than a threshold. Therefore, even in a case where the orientation of the operation unit is significantly different from the orientation of the camera to be remotely controlled, it is possible to suppress a situation in which a capture direction of the camera is controlled to be an unintended direction.

### Second Embodiment

Next, a second embodiment according to the present disclosure will be described. The present embodiment relates to display on the remote control apparatus 800 during the disabled period of the remote control apparatus 800 according to the first embodiment. As the present embodiment can be carried out in the image capture system described in the first embodiment, a description of matters similar to those of the first embodiment is omitted.

First, a description is given of an example that provides a display for informing a user of the remote control apparatus 800 of a state where the remote control apparatus 800 is disabled during the disabled period of the remote control apparatus 800, using a flowchart shown in FIG. 23A.

Step S803 can be carried out when the CPU 101 executes step S707 of FIG. 20 for the first time. The CPU 101 notifies the remote control apparatus 800 of a state where operations are disabled via the network I/F 105. At this time, the CPU 101 may provide a notification of the difference between orientations calculated in step S706 as well.

In step S804, the CPU 801 of the remote control apparatus 800 receives the notification from the capture control apparatus 100. Then, the CPU 801 displays information indicating that operations on the operation unit 812 are disabled on the display unit 808.

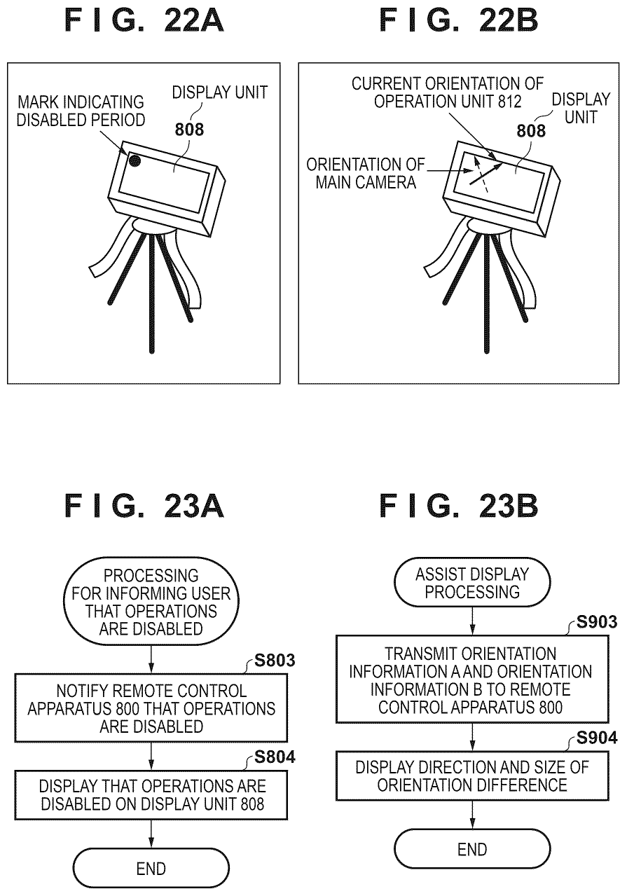

FIG. 22A shows an example in which a circular mark indicating that operations on the operation unit 812 are disabled is displayed on the display unit 808. Note that the shape of the mark may be any other shapes, such as a quadrilateral shape and a star shape. Also, in a case where the notification of the difference between orientations is provided, the size or the number of the mark(s) may be changed in accordance with the magnitude of the difference between orientations. For example, the difference between orientations may be divided into a plurality of levels, and a mark of a size, or the number of marks, corresponding to a level may be displayed. Furthermore, such a message as “operations are temporarily disabled due to a shift between the orientation of the main camera and the orientation of the operation unit” may be displayed in place of, or in addition to, the mark(s).

Thereafter, when executing step S708 of FIG. 20, the CPU 101 notifies the remote control apparatus 800 of a state where operations are enabled. In response to this notification, the CPU 801 ends the display that was started in step S804. At this time, the CPU 801 may display such a message as “operations have been enabled” on the display unit 808.

As described above, the user can be prompted to make the orientation of the operation unit match the orientation of the main camera by being informed of a state where operations are disabled via the remote control apparatus 800.

Next, a description is given of an example that provides a display for informing a user of the magnitude and direction of the difference between orientations a camera to be operated and the operation unit 812 during the disabled period of the remote control apparatus 800, using a flowchart shown in FIG. 23B.

Step S903 can be carried out when the CPU 101 executes step S707 of FIG. 20 for the first time. The CPU 101 notifies the remote control apparatus 800 of a state where operations are disabled via the network I/F 105. At this time, the CPU 101 provides a notification of the orientation information A and the orientation information B obtained in steps S704 and S705 (or the difference between orientations calculated in step S706) as well.

In step S904, the CPU 801 of the remote control apparatus 800 receives the notification from the capture control apparatus 100. Then, the CPU 801 displays information indicating the direction and magnitude of the difference between orientations of the main camera and the operation unit 812 on the display unit 808.

For example, in a case where the pieces of orientation information include a pan angle and a tilt angle, the CPU 801 generates a vector indicating a capture direction of the main camera from the orientation information of the main camera, and generates a vector indicating a capture direction corresponding to the orientation of the operation unit from the orientation information of the operation unit 812. Then, the CPU 801 converts each vector into, for example, a two-dimensional vector projected on a vertical plane. Furthermore, the CPU 801 displays information based on the two-dimensional vectors on the display unit 808.

FIG. 22B shows an example in which an arrow indicating the orientation (capture direction) of the main camera, and an arrow indicating a capture direction corresponding to the orientation of the operation unit 812, are displayed. The user can perceive the direction and magnitude of the difference between orientations based on the difference between the directions of the arrows. Therefore, the user can understand in which direction the operation unit 812 is to be operated to match the orientation of the main camera.

Other display methods are also possible. The CPU 801 calculates each of the difference between pan angles and the difference between tilt angles based on the pieces of orientation information of the main camera and the operation unit 812. Then, the CPU 801 converts the direction and magnitude of the difference between pan angles into a vector in the horizontal direction, and the direction and magnitude of the difference between tilt angles into a vector in the vertical direction. Then, the CPU 801 displays arrows based on these vectors on the display unit 808. The directions and magnitudes of the differences between the tilt angles and the pan angles are indicated by different arrows; this enables the user to correct a shift between orientations on a per-direction basis.

Note that marks other than arrows may be used. For example, the directions may be indicated using different colors, and the magnitudes may be indicated using color densities. Also, the directions may be indicated using positive and negative signs, and the magnitudes may be indicated using numerical values. Furthermore, it is possible to display a message providing an instruction for an operation necessary to eliminate the difference, such as “please perform a pan operation by X degrees in a rightward direction”.

During the disabled period, the CPU 101 and the CPU 801 repeatedly execute steps S903 and S904. In this way, the display content of the display unit 808 is updated, and the user operates the operation unit 812 so that the difference between orientations becomes small while viewing the display unit 808; as a result, the difference between orientations of the main camera and the operation unit 812 can be corrected quickly.

Note that the two display examples described here may be carried out in combination. Furthermore, although the above performances have been described as being carried out by the CPU 101 and the CPU 801, all of the performances may be carried out by the CPU 801. In this case, when the role control apparatus 600 has provided a notification of a new main camera, the CPU 801 may obtain pieces of orientation information from the main camera and the orientation calculation unit 807, and execute processing shown in the flowcharts of FIGS. 23A and 23B.

According to the present embodiment, even if the main camera has been changed and the operation unit has been disabled due to a difference between orientations of the main camera and the operation unit, the user can quickly correct a shift between the orientations of the main camera and the operation unit, and enable a remote operation on the main camera by the operation unit.

### OTHER EMBODIMENTS

Although the capture control apparatus 100 and the remote control apparatus 800 are individual apparatuses in the above-described embodiments, they may be the same apparatus. Therefore, the remote control apparatus 800 can function also as the capture control apparatus 100. Also, the capture control apparatus 100 can function also as the remote control apparatus 800.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-171512, filed Sep. 30, 2024, which is hereby incorporated by reference herein in its entirety.

What is claimed is:

1. A capture control apparatus, comprising:
one or more processors that execute a program stored in a memory, wherein the program, when executed by the one or more processors, causes the one or more processors to perform:
controlling a performance of a second image capture apparatus among a plurality of image capture apparatuses including a first image capture apparatus and the second image capture apparatus, based on information related to the first image capture apparatus and control descriptions that have been set; and
in a case where the first image capture apparatus has been changed within the plurality of image capture apparatuses, determining whether a difference between an orientation of an operation member for remotely controlling a capture direction of the first image capture apparatus and an orientation of the current first image capture apparatus is equal to or smaller than a threshold,
wherein in a case where it has been determined that the difference is not equal to or smaller than the threshold, the controlling disables the remote control by the operation member until it is determined that the difference is equal to or smaller than the threshold.

2. The capture control apparatus according to claim 1, wherein
while the remote control by the operation member is disabled, the controlling controls a performance of the current first image capture apparatus, based on the control descriptions when the current first image capture apparatus was the second image capture apparatus.

3. The capture control apparatus according to claim 1, wherein
while the remote control by the operation member is enabled, the first image capture apparatus is controlled so that an orientation matches that of the operation member.

4. The capture control apparatus according to claim 1, wherein
the operation member includes a camera platform capable of executing a pan performance and a tilt performance.

5. The capture control apparatus according to claim 4, wherein
the operation member includes a display unit, and
the display unit is provided so that a screen thereof is located at a front when a pan angle has an initial value.

6. The capture control apparatus according to claim 1, wherein
the operation member includes a display unit, and
a live-view video of the first image capture apparatus is displayed on the display unit.

7. The capture control apparatus according to claim 6, wherein
while the remote control by the operation member is disabled, the live-view video is not displayed.

8. The capture control apparatus according to claim 6, wherein
while the remote control by the operation member is disabled, information indicating that the remote control by the operation member is disabled is displayed on the display unit.

9. The capture control apparatus according to claim 6, wherein
while the remote control by the operation member is disabled, information indicating a direction and a magnitude of a difference between an orientation of the current first image capture apparatus and an orientation of the operation member is displayed on the display unit.

10. The capture control apparatus according to claim 1, wherein
the controlling controls at least one of a tracking target subject or an angle of view of the second image capture apparatus.

11. A capture control method comprising:
controlling a performance of a second image capture apparatus among a plurality of image capture apparatuses including a first image capture apparatus and the second image capture apparatus, based on information related to the first image capture apparatus and control descriptions that have been set;
in a case where the first image capture apparatus has been changed within the plurality of image capture apparatuses, determining whether a difference between an orientation of an operation member for remotely controlling a capture direction of the first image capture apparatus and an orientation of the current first image capture apparatus is equal to or smaller than a threshold; and
in a case where it has been determined that the difference is not equal to or smaller than the threshold, disabling the remote control by the operation member until it is determined that the difference is equal to or smaller than the threshold.

12. A non-transitory computer-readable medium storing a program for causing a computer to perform a capture control method comprising:
controlling a performance of a second image capture apparatus among a plurality of image capture apparatuses including a first image capture apparatus and the second image capture apparatus, based on information related to the first image capture apparatus and control descriptions that have been set;
in a case where the first image capture apparatus has been changed within the plurality of image capture apparatuses, determining whether a difference between an orientation of an operation member for remotely controlling a capture direction of the first image capture apparatus and an orientation of the current first image capture apparatus is equal to or smaller than a threshold; and
in a case where it has been determined that the difference is not equal to or smaller than the threshold, disabling the remote control by the operation member until it is determined that the difference is equal to or smaller than the threshold.
